(19) United States
(12) Patent Application Publication
(10) Pub. No.: US 2008/0136916 A1
(43) Pub. Date: Jun. 12, 2008

(54) Eye tracker/head tracker/camera tracker controlled camera/weapon positioner control system

(76) Inventor: Robin Quincey Wolff, Grahamsville, NY (US)

Correspondence Address: FURGANG & ADWAR, 2 CROSFIELD AVENUE, WEST NYACK, NY, 10994, US

(21) Appl. No.: 11/339,551

(22) Filed: Jan. 26, 2006

Related U.S. Application Data
(63) Continuation-in-part of application No. 11/043,878, filed on Jan. 26, 2005.

(51) Int. Cl. G06K 9/00; G06F 3/033; H04N 5/225

(52) U.S. Cl. 348/169; 382/103; 382/118; 345/158; 382/117; 348/E07.09

(57) ABSTRACT

A user has both a head tracker and eye tracker sending signals to a processor to determine the point of view of the user. The processor also receives signals indicative of the point of view of a camera, weapon or laser target designator. The microprocessor compares the two points of view and sends instructions to the camera, weapon or laser target designator to adjust its position to align the points of view. In another embodiment the optical devices are supported on orbital tracks attached to a helmet. The optical devices are fully mobile to follow the user's eyes through any_movement. The helmet mounted system can automatically adjust for any user and has a counterweight to balance the front armature.

### FIELD OF THE INVENTION

The invention relates to a system and method for tracking a target and related devices and systems.

### BACKGROUND OF THE INVENTION

Systems permitting the user to remotely operate a camera have become commonplace in the film and video production industry during the last decade, such as disclosed in U.S. Pat. No. 4,683,770 (Nettmann). Other systems allow a camera to be remotely operated mounted to an unstable vehicle by counteracting g-forces using gyroscopes disclosed in U.S. Pat. No. 4,989,466 (Goodman). Systems providing teleoperation of weapons have been documented in use since 1915 when Australian Lance Corporal W. C. B. Beech invented the “Sniperscope.” This concept was used by Rowe (Design Pat. No. 398,035), and has been further automated by Hawkes et al. (U.S. Pat. Nos. 6,237,462 and 6,269,730).

These systems allow the user to position and operate a camera or weapon from a remote location, but they require the user to manipulate the aiming controls of the camera or weapon positioning device by hand. While these systems can position a device, even on an unstable platform, they usually require a second person to control other features of a camera, such as the focus and zoom motors that position the adjustment rings on camera. The activity of manipulating hand controls to position the camera/weapon requires voluntary control movement that are not automatic or reflexive. This means that the user must think in order to make his hands manipulate the controls, usually wheels or joysticks, for controlling the tilt and pan axes of the positioning device to point the instrument of choice.

Saccades, quick and abrupt eye movements, are evoked by, or conditioned upon, visual, vestibular or other sensory stimuli. Anyone who habitually watches televised sports has noticed when the cameraman shooting the event aims the camera where he thinks a target, usually a ball, is going, rather than where he and the people watching the game in person, see it, only to recover and aim the camera at the point of interest again. Objects in motion are automatically followed by the human ocular control system when a person views a moving object. The thought processes, which send signals from the brain to the hands, which manipulate aiming controls, are an unnecessary weak link in the system in view of available technology.

The need for an automated system, removing the human thought process, and the second operator, from the control of a teleoperated camera/weapon aiming system is, therefore, evident.

Eye tracking devices having many uses which are disclosed as in U.S. Pat. No. 6,102,870 (Edwards) and U.S. Pat. No. 5,293,187 (Knapp). Eye tracker controlled cameras have been mentioned in patents, such as U.S. Pat. No. 5,726,916 (Smyth) which discloses this use in a list of possible uses for his eye tracker design. Another, U.S. Pat. No. 5,984,475 (Galiana et al.) describes a gaze controller for a stereoscopic robotic vision system. U.S. Pat. No. 6,307,589 (Maquire, Jr.) uses an eye position monitor to position a pair of head mounted cameras, but the described system is centered on a retinal (i.e., focused only in the center of image) view.

These devices either go too far in an attempt to replicate human vision or not far enough. On the other hand, a better approach is an automatic system, which allows the user to accurately and immediately capture an image of a target that is being viewed by the user, while at the same time affording the user and the positioning device all degrees of freedom in and of themselves and in relation to a multitude of stationary points in space. Such a system may capture the image for film or video or may be used to aim a weapon.

Other systems use light intensifier tubes to maximize a user's night vision capability to allow piloting of aircraft at night. These systems are inherently limited in the field of view they provide because of the limited maneuverability of the tube mounts. Later systems, such as Moody, in U.S. Pat. No. 6,462,894, place four intensifier tubes in pairs to give the user a wider field of view, but they still require that the user must move his head in order to look in a certain direction, especially up and down, and do not provide for parallax vision. Designers have also attempted to mount cameras on the head of a user in different configurations, but none have replicated the human parallax vision system. The need for a parallax view night vision/camera device is therefore evident.

### SUMMARY OF THE INVENTION

The system, which may have a headset containing a head tracker device, has a system of spread spectrum localizers and receiver circuitry such as that disclosed by Fleming et al. (U.S. Pat. No. 6,400,754) and McEwan (U.S. Pat. Nos. 5,510,800 and 5,589,838). Such systems may be used for tracking the user's head in three-dimensional space as well as tracking the position with regard to the X (tilt) and Y (pan) axes of the head of the user in relation to a multitude of stationary reference localizers in different planes. The system may also incorporate an eye tracker mounted in goggles contained within a headset to provide signals which may correspond to the position of the user's eyes in relation to his head as well as the parallax created by the convergence of the user's eyes, and, hence, the distance of the user's point of regard with relation to the user. These signals may be sent to a microprocessor to compute the point of regard of the user in relation to a multitude of stationary localizers in different planes for reference.

A camera tracker or weapon tracker has a system of spread spectrum localizers and receiver circuitry, as disclosed by Fleming et al. (U.S. Pat. No. 6,400,754), mounted on a remote camera positioning device which tracks the position of a camera or weapon in three-dimensional space. Data from the eye tracker, head tracker, and camera tracker and encoders on motors controlling the rotation about the X (tilt) and Y (pan) axes of the camera positioning device and Z axis (focus distance) of the camera via a camera lens LE, is used to compute the point of regard of the user in relation to that of the camera, by the microprocessor, to continuously calculate a new point of regard in three-dimensional space for the camera. The microprocessor may send error values for each motor in the camera positioning device controlling the tilt (X axis), pan (Y axis), and focus (Z axis) of the camera to the controller. The controller may use different algorithms to control the camera positioning device motors depending on the speed and distance of the motion required, as determined by the speed and distance of the tracked saccade. The signals may be sent to a digital to analog converter and then to an amplifier that may amplify the signals and send them to their respective motors.

Signals from manual controllers and control motors, which may position f-stop and zoom motors on the camera, may also be sent to the controller and amplifier and sent to the camera positioning device and then to respective motors. In the case of a weapon aiming system, hand controllers may be used to fire the weapon as disclosed by Hawkes et al. (U.S. Pat. Nos. 6,237,462 and 6,269,730), incorporated herein by reference, and to adjust for windage and/or elevation.

Another embodiment of the invention may comprise a headgear-mounted pair of slim rotary motor actuated convex tracks on rotating axes positioned in line with and directly above the axes of a user's eyes. Attached to both tracks are motor driven image intensified tube/camera/flir mounts that sandwich the track with a smooth wheel positioned inside a groove in the outside portion of the track, and a pair of gears fitted into gearing that runs the operable length of the inside of the track.

A headgear-mounted eye tracker may track the movement of the user's eyes. A microprocessor may receive position data from the eye tracker and headgear which may be mounted on orbital positioning device motors. The microprocessor may calculate the error, or difference, between the point of regard of the user's eyes in relation to the user's head, and the actual point of regard of the optical axis of the positioning device mounted optical devices by way of motor encoder actual positioning data. The controller may send new position signals to motors which may position the convex orbital tracks and track mounted mounts so as to have the intensifier tubes always positioned at the same angle in relation to the user's line of sight. A wide-angle collimating optical device, such as disclosed in U.S. Pat. No. 6,563,638 (King et al.), may allow the user to see a side-angle view of the surrounding area. This wide-angle collimating optical device may be combined with the orbital positioning device to give the user a wider field of vision than the natural field of human vision.

The orbital positioning night vision devices may allow the user to view the scene around him at night using his natural eye movements instead of having to move his head in order to see a limited field of view. It also may allow the user to view the scene with peripheral vision that is limited by the optics and helmet design.

In yet another embodiment, the orbital positioning device mounted camera may allow the user to view the scene around him via a display. The display may produce a parallax view as is produced by the orbital positioning system which provides dual image signals mimicking the human visual system. This system may more readily produce a 3D image that replicates that of a human being because it positions optical devices at the same angles that the user's eyes use to view the image, in real-time, by tracking the user's eye movements and using the tracking data to independently control camera positioning devices that maneuver the cameras at an equal distance from the center of each of the user's eyes on any point within the user's field of view.

This system may provide adjustable positioning of orbital tracks that are mounted to a user's helmet. Because a wide range of user's head, facial, and more importantly, interpupilary dimensions, which differ in the range of 0.8 inches, these positioning devices must be adjustable if a large number of users are to be accommodated. Moreover, the measurement and adjustment in real-time may be automated to allow for realignment of the mounted devices. Means for adjustment for front and back movements (in relation to the user's head) of the orbital track is contemplated within the scope of this invention.

It is an object of the invention to provide a tracking system using both an eye tracker and head tracker.

It is another object of the invention to provide a tracking system to allow a camera, weapon, laser target designator, or the like to track an object.

It is yet another object of the invention to provide a helmet mounted orbital positioning device.

It is yet another object of the invention to provide an automatic adjustment system for the orbital positioning device.

It is still another object of this invention to provide a remotely positioned orbital positioning device.

### BRIEF DESCRIPTION OF THE DRAWINGS

FIG. 1 is a schematic depiction of an ultra wide band localizer head tracker/camera tracker and eye tracker equipped headset control system, wireless data-link between the user, camera positioning device, and major control elements, film or digital camera, video tap, video recorder, and monitor;

FIG. 2 is a schematic depiction of the ultra wide band localizer head tracker/camera tracker and eye tracker equipped headset control system, wireless data-link between the user, camera positioning device, and major control elements, film camera, video tap, image processor auto tracking device, video recorder, and monitor;

FIG. 3 is a schematic depiction of the ultra wide band localizer head tracker/camera tracker and eye tracker equipped headset control system, wireless data-link between the user, camera positioning device, and major control elements, video camera, auto tracking device, video recorder, and monitor;

FIG. 4 is a schematic depiction of the ultra wide band localizer head tracker/camera tracker and eye tracker equipped headset control system, wireless data-link between the user, camera positioning device, and major control elements, video camera, auto tracking device, video recorder, and monitor;

FIG. 5 is a schematic depiction of the ultra wide band localizer head tracker/weapons tracker and eye tracker equipped headset control system, wireless data-link between the user, camera positioning, and major control elements, video camera, auto tracking device, video tap, video recorder, and monitor;

FIG. 6A is a perspective view of a user in a vehicle and an enemy;

FIG. 6B is an enlarged partial side view of the user shown in FIG. 6A.

FIG. 7A is a schematic representation of a pair of tracking devices in a misaligned position;

FIG. 7B is a schematic representation of a pair of tracking devices in an aligned position;

FIG. 8 is a diagram showing the laser range finding geometric tracking arrangement;

FIG. 9A is a perspective view of a tracker;

FIG. 9B is a perspective view of the opposed side of the tracker of FIG. 9A;

FIG. 10 is a perspective view of another tracker with an optical box;

FIG. 11 is a diagrammatic view of a user wearing an eye tracker and an orbital tracking system;

FIG. 12 is a schematic of a head mounted orbital display system;

FIG. 13 is a schematic of the camera display system in FIG. 12;

FIG. 13A is a right side view of a stereoscopic display positioner;

FIG. 13B is a top schematic view of both stereoscopic display positioners in operating position;

FIG. 14A is top, side, and front views of a female dovetail bracket;

FIG. 14B is top, side, and front views of a male dovetail bracket;

FIG. 14C is top, side, and front views of an upper retaining cover;

FIG. 14D is top, side, and front views of a lower retaining cover;

FIG. 14E1 is an exploded view of the dovetail bracket assembly with optical devices;

FIG. 14E2 is a perspective view of the bracket assembly;

FIG. 14E3 is a perspective view of the bracket assembly of FIG. 14E2 with mounted optical devices.

FIG. 15A is a schematic top view of the see-through night vision mounting arrangement;

FIG. 15B is a schematic enlarged partial view of the left support member shown in FIG. 15A;

FIG. 15C is a schematic side view taken along line 36 of FIG. 15B and looking in the direction of the arrows 15C;

FIG. 15D is a schematic rear view taken along line 47 of FIG. 15B and looking in the direction of the arrows 15D;

FIG. 15E is a schematic side view taken along line 48 of FIG. 15B and looking in the direction of arrows 15E;

FIG. 16A is a front view of the helmet-mounted orbital positioning device;

FIG. 16B is a side view of the helmet-mounted orbital positioning device;

FIG. 16C is a rear view of the helmet-mounted orbital positioning device;

FIG. 16D is a top view of the helmet-mounted orbital positioning device;

FIG. 17 is an enlarged side close up view of the dorsal mount of FIG. 15B;

FIGS. 18A-C are detailed front, side, top views of the horizontal support member and FIGS. 18 D1-E1 are mirror imaged right angle retainers with FIG. 18D2 is a side view of the right angle retainer taken along line 844 and looking in the direction of the arrows in FIG. 18 D1 and of FIG. 16E2 is a front view of the right angle retainer taken along line 846 and looking in the direction of the arrows;

FIG. 18F is an exploded perspective view of the horizontal support member of FIGS. 16A-D;

FIG. 19 is a perspective view offset orbital tracks and drive masts;

FIG. 20 is a sectioned view of the slider mount of FIG. 18C taken along line 49 and looking in the direction of arrows 20;

FIG. 21 is a sectional view of the orbital track carriage of FIG. 19 taken along line 50 and looking in the direction of arrows 21A;

FIG. 22 is a top view of the orbital tracks in a swept back position;

FIG. 23A is a rear view of the active counterweight system;

FIG. 23 B is a left side view of the counterweight system of FIG. 23A;

FIG. 24A is a close-up rear view of the active counterweight system;

FIG. 24B is a sectional view of the active counterweight system taken along line 53 and looking in the direction of arrows 24B in FIG. 24A;

FIG. 25A is a stand mounted self-leveling orbital track pair;

FIG. 25B is a detailed view of the orbital system;

FIG. 25C is a perspective view of the slider and motor mounts for the orbital track system;

FIG. 25D is a sectional view of the slide base and snap on motor mount of FIG. 25 B taken along a line and viewed in the direction of the arrows 25D; and

FIG. 25E is a disassembled view of the slide base of FIG. 25B.

### DETAILED DESCRIPTION OF THE PREFERRED EMBODIMENTS

Throughout the specification, similar devices and signals are identified with the same identification indicia.

This invention is directed to a tracking system of the type used by a human user. There is provided eye tracking means for tracking the dynamic orientation of the eyes of the user (i.e., the orientation of the eyes in three dimensions with respect to the head). Head tracking means are provided for tracking the dynamic orientation of the head of the user (i.e., the orientation and position of the head in three dimensions in space). At least one positioning device (e.g., a tilt and pan head, a rotary table, or the like) is also provided. There are also provided means for tracking the dynamic orientation of the positioning device (i.e., the orientation and position of the positioning device in space). The eye tracking, head tracking, and positioning device tracking means provide signals to a computer processor from which the eyes of the user directs the position device to capture a target for photographic, ballistic, or similar purposes.

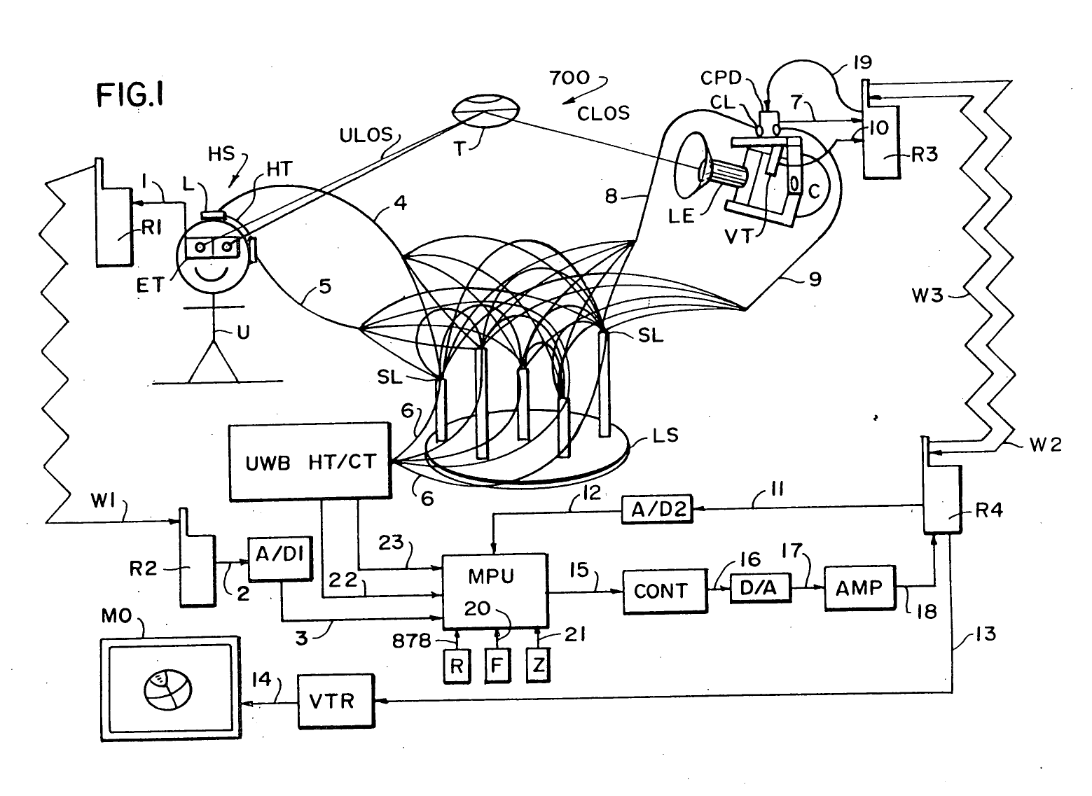

As shown in FIG. 1, a user U may wear a headset HS which may be secured to an eye tracker-head tracker ET/HT (which are well known in the art). The eye tracker ET tracks the user's U line of sight ULOS in relation to his/her head as the user U views a target T. The eye tracker ET sends signals 1 to a transceiver R1. The transceiver R1 may transmit radio signals W1 to a radio link receiver R2. The radio link receiver R2 sends signals 2 to an analog to digital converter A/D1. The analog-digital converter A/D1 converts the transmitted analog signals from the eye tracker ET to a digital format and sends digital signals 3 to a microprocessor unit MPU.

Localizers L, of the type disclosed in the patent by Fleming et al., may be mounted to the headset HS in predetermined locations. The localizers L prove non-sinusoidal localizer signals 4, 5, which correspond to the X, Y and Z axes (only two localizers L, providing two signals 4, 5,—which correspond to the Y and X axes—of the position of the headset HS are shown). As more fully taught by Fleming et al., these signals are sent to a multitude of stationary localizers SL which may be secured to a stand LS. The stationary localizers SL are disposed in different horizontal and vertical planes. As further taught by Fleming et al., the position location of the head set may be derived using synchronized internal clock signals which allow the system 700 to measure the time taken for each transceiver to receive signals. Receiver circuitry UWB HT/CT receives signals 6 from the stationary localizers SL. Then, by comparing these signals, it calculates a three dimensional position tracking with an accuracy of 1 cm.

A camera positioning device CPD may use motors (not shown) to change the position of a camera C in the X-pan, Y-tilt, and Z-focus axes. Encoders (not shown) may be attached to these motors to provide signals which correspond to the actual position of the camera C in relation to the base of the camera positioning device CPD. Throughout it will be understood that, except where otherwise indicated, it is contemplated that reference to a “camera” encompasses any means for recording images, still or moving, including, but not limited to film or digital cameras. The camera positioning device CPD sends signals 7 to radio transceiver R3. A camera tracker CT (which may correspond to that disclosed by Fleming, et al.) may consist of localizers CL. The localizers CL may be attached to the camera positioning device CPD at predetermined locations. By obtaining the distance of the camera's lens LE in relation to the camera positioning device CPD in the X, Y and Z plane the calculated look point of the camera C may be defined. The receiver circuitry UWB HT/CT tracks the position of the camera C′ in relation to a multitude of stationary localizers SL in each of its respective vertical and horizontal planes, via localizer signals in each of three axes (only signals 8 and 9 corresponding to the X, Y axes are shown).

A video tap VT may send video signals 10 to transceiver R3. Transceiver R3 transmits signals groups 7 and 10, in the form of radio signals W2, to a radio transceiver R4. Radio transceiver R4 may receive radio signals W2 and sends signal groups 11 corresponding to signals 7 to an analog/digital converter A/D2. Analog/digital converter A/D2 converts signals 11 from analog to digital signals and sends corresponding digital signals 12 to the microprocessor unit MPU. Radio transceiver R4 sends composite video signals 13, which correspond to video tap VT video signals 10, to a video recorder VTR (which may be tape or hard drive recorder or the like) that, in turn, sends signals 14, which corresponds to video tap VT video signals 10, to a monitor MO.

The microprocessor unit MPU calculates the user's U point of regard using positions of the user's U head and eyes, as tracked by the eye tracker ET and receiver circuitry UWB HT/CT. The microprocessor unit MPU also calculates the actual point of regard of the camera C, using camera position signals 23 of the receiver circuitry UWB HT/CT, and signals 12 from the camera positioning device CPD (including the focus distance Z-axis of camera C). The microprocessor unit MPU compares the actual point of regard of the user U to the actual point of regard of the camera C and continually calculates the new point of regard of the camera C. New position signals 15 for each motor (not shown), controlling each axis of the camera positioning device CPD, are sent to the controller CONT. The controller CONT sends signals 16 to a digital to analog converter D/A that, in turn, converts digital signals 16 into an analog signals 17 and sends signals 17 to an amplifier AMP. Amplifier AMP amplifies the signals 17 and sends the amplified signals 18 to the transceiver R4. Transceiver R4 transmits amplified signals 18, in the form of radio signals W3, to transceiver R3. Transceiver R3 receives radio signals W3 and sends corresponding signals 19 to the camera positioning device CPD motors for controlling each axis of the camera positioning device CPD and the focus motor of a camera lens LE. Signals 878, 20, and 21, which are from manual controls run R, f-stop F, and zoom Z, respectively, are sent to the microprocessor unit MPU and to the lens LE.

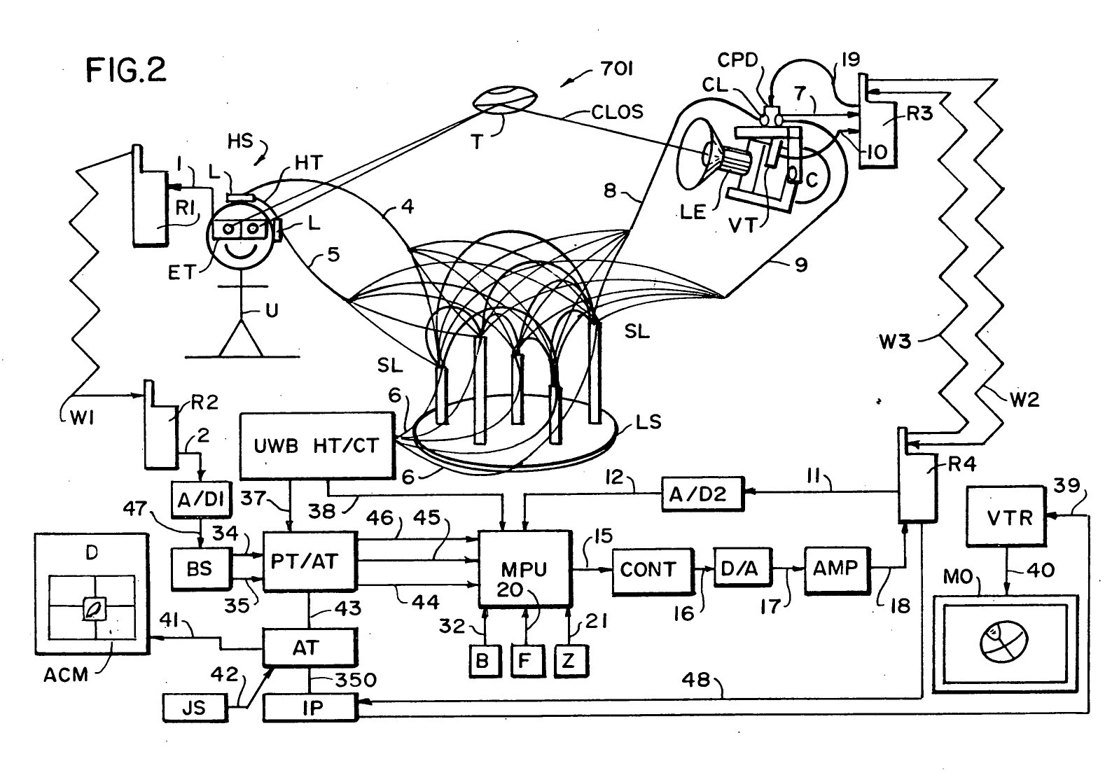

Another embodiment of the invention shown (FIG. 2), may combine an auto tracking target designator AT, as disclosed by Ratz (U.S. Pat. No. 5,982,420), the disclosure of which is incorporated herein by reference. This embodiment uses the same devices and signals as that shown in FIG. 1 and which are identified by the same reference numbers and letters. The differences are described below.

The auto track target designator AT of FIG. 2 tracks a selected portion of the composite video signals 10 provided by video tap VT. In one mode, when the user U wishes to break eye tracker ET and head tracker HT control for any reason, the user U throws the person tracker/auto tracker switch PT/AT. This switch PT/AT switches control of the motors of the camera positioning device CPD from the eye tracker-head tracker ET/HT to the auto track target designator AT. The auto track target designator AT tracks the selected object area of the composite video signals which are provided by the primary camera (in the case of video cameras), or by a fiber-optically coupled video tap (as disclosed by Goodman (U.S. Pat. No. 4,963,906), the disclosure of which is incorporated herein by reference), in the case of film cameras. In FIG. 2, the user U may wear the headset HS containing an eye tracker-head tracker ET/HT. The eye tracker ET tracks the user's U line of sight ULOS in relation to the user's head as user U views the target T. Signals 2 are sent from the radio link receiver R2, to analog to digital converter A/D1 that, in turn, sends digital signals 47 and, distinguishing from the device of FIG. 1, this signals 47 goes to a blink switch BS. Signals 34 corresponding to signals 2, are sent to the person tracker/auto tracker switch PT/AT. Another mode allows the blinking of the user's U eyes to momentarily break the control signals sent to the microprocessor unit MPU from the eye tracker ET. The measurement of the time it takes the user U to blink is set forth in the patent by Smyth (U.S. Pat. No. 5,726,916) and incorporated herein. This measurement can be used to switch the person tracker/auto tracker switch PT/AT for the measured time via signals 35 so that the signals 44 from the auto track target designator AT are sent to the microprocessor unit MPU for the given period of time. Thus, the target T is continually and accurately viewed by the camera C despite the user's U blinking activity.

The receiver circuitry UWB HT/CT sends the head tracker HT signals 37 and camera tracker CT signals 38, corresponding to their position in three-dimensional space, to the person tracker/auto tracker switch PT/AT and microprocessor unit MPU, respectively. The camera positioning device CPD uses motors (not shown) to change the position of the focal plane of camera C in the X-pan, Y-tilt, and Z-focus axes. Encoders attached to these motors provide signals corresponding to actual positions of the different axes of the camera positioning device CPD in relation to the base of the camera positioning device CPD.

The camera positioning device CPD sends signals 7 to radio transceiver R3. Video tap VT also sends a video signals 10 to transceiver R3. Transceiver R3 transmits signals 7, 10 in the form of radio signals W2, to the radio transceiver R4. Transceiver R4 receives radio signals W2 and sends signals 11, corresponding to signals 7, to analog to digital converter A/D2. Analog/digital converter A/D2 converts signals 11 from analog to digital and sends the corresponding signals 12 to the microprocessor unit MPU. Transceiver R4 sends composite video signals 48 corresponding to signals 10 to image processor IP as disclosed by Shnitser et al. (U.S. Pat. No. 6,353,673), the disclosure of which is incorporated herein by reference. Because the video signals 10 provided to the auto tracker designator AT is from the video tap on a film camera C, the image flickers as the camera runs, as is well known. The auto tracker designator AT uses differences in successive video frames in order to track a target T. In order to provide the auto tracker with clean video signals, the image processor must remove the flicker from the video signals so as to provide an uninterrupted image so that the auto tracker can operate properly. Thus, image processor IP provides the auto track target designator AT via signals 350 a clean composite video image. The image processor IP sends duplicate signals 39 to the video recorder VTR which sends duplicate signals 40 to a monitor MO. (Where an image processor is used in combination with the system of this invention, such a processor is to be used with a film camera.)

The auto track target designator AT sends signals 41, corresponding to signals 10, to a display D that displays the images sent by the video tap VT as well as the auto track target designator AT created area-of-concentration marker ACM that resembles an optical sight (as taught by Shnitser et al.). A joystick JS controls the placement of this marker and may be used without looking at the display, or by a secondary user. The area-of-concentration marker ACM marks the area of the composite video signals that the auto track target designator AT tracks as the user U views the target T, allowing a particular object or target to be chosen. The joystick JS sends signals 42 to the auto track target designator AT which tracks the image of the object displayed inside the marker of the display D by comparing designated sections of successive frames of composite video signals 350, and sends new position signals 43 to the person tracker/auto tracker switch PT/AT. When the person tracker/auto tracker switch PT/AT is switched to auto track target designator AT, signals 34 and 37, which correspond to signals from the eye tracker ET and head tracker HT, respectively, are bypassed and the person tracker/auto tracker PT/AT signals 44 corresponding to auto track target designator AT signals 43 are sent to the microprocessor unit MPU in their place.

When the person tracker/auto tracker switch PT/AT is set to person tracking PT, the microprocessor unit MPU receives signals 45 and 46 corresponding to signals 34 and 37 from the eye tracker ET and receiver circuitry UWB HT/CT and calculates the point of regard to the user's U eyes and head as tracked by the eye tracker ET and receiver circuitry UWB HT/CT.

The microprocessor unit MPU compares the actual point of regard of the user U to the actual point of regard of the camera C, and continually calculates the new point of regard of the camera C sending new error position signals 15 for each motor controlling each axis (X, Y, and Z) of the camera positioning device CPD and lens LE to the controller CONT. The controller CONT produces signals 16 that are sent to a digital to analog converter D/A that converts digital signals 16 into analog signals 17 and sends the signals 17 to amplifier AMP and sends the amplified signals 18 to transceiver R4. Transceiver R4 transmits radio signals W3 to transceiver R3. Transceiver R3 receives radio signals W3 and sends signals 19 to the camera positioning device CPD and its motors (not shown) to control each axis of the camera positioning device CPD and camera lens LE.

A focusing device (not shown) as disclosed by Hirota et al. (U.S. Pat. No. 5,235,428, the disclosure of which is incorporated herein by reference) or a Panatape II or a Panatape Long Range by Panavision, 6219 De Soto Avenue, Woodland Hills, Calif. 91367-2602, or other manual or automatic autofocusing device, may control the focus distance of the camera C when the auto track target designator AT is in use because the parallax-computed focus distance of the eye tracker ET is no longer sent to the microprocessor unit MPU. Signals from an automatic focusing device (not shown) may be sent to the camera positioning device CPD and then to the microprocessor unit MPU. F-stop controller signals 20 and zoom controller signals 21 from focus controller F and zoom controller Z, respectively, are sent to the microprocessor unit MPU and to the lens LE to control the zoom and focus.

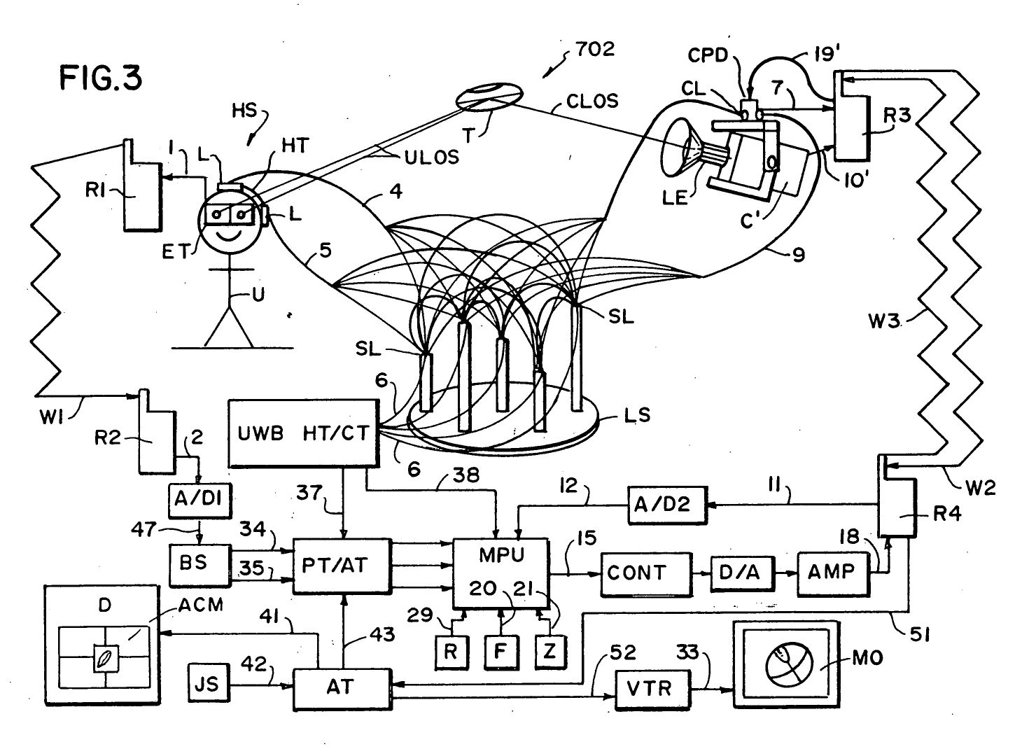

Another embodiment of the invention (FIG. 3) also combines wireless transmitter/receiver radio data link units R1-R4 and an auto tracking target designator AT as disclosed by Ratz (U.S. Pat. No. 5,982,420), the disclosure of which is incorporated herein by reference. The entire system 701 is generally the same as that disclosed in FIG. 2 except that instead of a film camera C there is a video camera C′. Because a video camera C′ is used, there is no need for the image processor described and shown in FIG. 2. The auto tracking target designator AT tracks a user selected portion of the composition video signals 10′ provided by the video camera C′. In one mode, when the user U must break eye tracker-head tracker HT/ET control for any reason, the user U throws a switch PT/AT which switches control of the camera positioning device CPD motors (not shown) from the eye tracker-head tracker ET/HT to the auto tracking target designator AT which tracks the object so as to provide a continuous target signals 44 to the microprocessor unit MPU. The auto tracking target designator AT tracks the selected object area of the composite video signals 10′ provided by the video camera C′. Another mode allows the user U to blink, thereby momentarily breaking the control signals sent to the microprocessor unit MPU from the eye tracker ET. Because the eye tracker design by Smyth (U.S. Pat. No. 5,726,916) uses electrooculography the time taken for the user U to blink his eyes and then acquire the target T can be measured.

In FIG. 3, user U may wear an eye tracker-head tracker ET/HT equipt headset HS. The eye tracker ET tracks the user's U line of sight ULOS in relation to the user U viewing the target T. Signals 1 from the eye tracker ET are sent to the transceiver R1. Transceiver R1 transmits radio signals W1 to radio receiver R2. Radio receiver R2 sends signals 2 to analog to digital converter A/D1 that sends digital signals 47 to the blink switch BS. Signals 34 corresponding to signals 2 are sent to the person tracker/auto tracker switch PT/AT. The blink switch BS sends signals 35 to switch the person tracker/auto tracker switch PT/AT for the given amount of time so that signals 43 from the auto tracking target designator AT are momentarily sent to the microprocessor unit MPU. The target T is continually and accurately viewed despite the user's U blinking activity. Head tracker HT sends non-sinusoidal localizer signals 4, 5 corresponding to headset localizers L to a multitude of stationary localizers SL, which may be secured to a stand LS, and the position location is continually derived using synchronized internal clocks which allow the system 702 to measure the time taken for each transceiver to receive the signals when compared to the multitude of stationary localizers SL in different horizontal and vertical planes.

Camera tracker CT, of the same design as the above described head tracker HT, has localizers CL mounted to the camera positioning device CPD. By obtaining the distance of the camera's lens LE in relation to the camera positioning device CPD in the X, Y and Z plane the calculated look point of the camera C′ may be defined. Localizers CL send signals 8 and 9 to the multitude of stationary localizers SL. The receiver circuitry UWB HT/CT tracks the position of the camera C′ in relation to a multitude of the stationary localizers SL in different vertical and horizontal planes via localizer signals 6 and sends calculated position data via signals 37 and 38, which correspond to the signals from the head tracker HT and camera tracker CT.

The microprocessor unit MPU calculates the user's U point of regard using positions of the user's U eyes and head as tracked by the eye tracker ET and receiver circuitry UWB HT/CT. The microprocessor unit MPU receives camera tracking signals 38 which correspond to signals 8, 9 from the receiver circuitry UWB HT/CT. The microprocessor unit MPU compares the actual point of regard of user U to the actual point of regard of camera C′ and continually calculates the new point of regard of camera C′ sending new error position signals 15 for each motor controlling each axis (X, Y, and Z) of the camera positioning device CPD to the controller CONT. The controller CONT produces signals 16 that are sent to a digital to analog converter D/A that converts digital signals 16 into analog signals 17 and sends signals 17 to amplifier AMP that amplifies signals 17 and sends the amplified signals 18 to transceiver R4. Transceiver R4 transmits radio signals W3 to transceiver R3. Transceiver R3 receives radio signals W3 and sends signals 19, corresponding to signals 18, to the camera positioning device CPD and the various motors controlling each axis of the camera positioning device CPD and camera lens LE.

The camera positioning device CPD uses motors (not shown) to change the position of the camera in the X-tilt, Y-pan, and Z-focus, axes of the camera C′. Encoders (not shown) provide signals corresponding to the actual positions of the different axes of the camera positioning device CPD in relation to the base of the camera positioning device CPD. The camera positioning device CPD sends encoder signals 7 to a wireless transceiver R3. Camera C′ sends composite video signals 10′ to transceiver R3. Radio signals W2, corresponding to signals 7, 10′, are sent from transceiver R3 to transceiver R4. Transceiver R4 receives radio signals W2 and sends signals 11 corresponding to signals 7 to the analog/digital converter A/D2. The analog/digital converter A/D2 converts signals 11 from analog to digital signals 12 and sends the digital signals 12 to the microprocessor unit MPU.

Composite video signals 10′ from camera C′ is sent to the transceiver R4 via radio signals W2. Transceiver R4 sends signals 51, corresponding to signals 10′, to the auto tracking target designator AT. The auto tracking target designator AT sends signals 41, which corresponds to signals 10′, to the display D that displays the images taken by the camera C′ as well as an auto tracking target designator AT created area-of-concentration marker ACM that resembles an optical sight. A joystick JS controls the placement of this marker ACM and may be used without looking at the display D. The area-of-concentration marker ACM marks the area of the composite video signals that the auto tracking target designator AT tracks as the user U views the target T, thereby allowing a particular object or target to be chosen. The joystick JS sends signals 42 to the auto tracking target designator AT which, in turn, tracks the image of the object displayed inside the marker of the display D by comparing designated sections of successive frames of a composite video signals and sends new position signals 43 to the person tracker/auto tracker switch PT/AT. When the person tracker/auto tracker switch PT/AT is switched to auto tracking target designator AT signals 34, 37 from the eye tracker ET and head tracker HT are bypassed and auto tracking target designator AT signals 44, which correspond to signals 43, are sent to the microprocessor unit MPU. When the person tracker/auto tracker switch PT/AT is switched to person tracker PT, signals 45, 46, which correspond to signals 34, 37, respectively, are sent to the microprocessor unit MPU and the auto tracking target designator AT signals 44 is bypassed.

A focusing device (not shown), as disclosed by Hirota et al., or other manual or automatic focus controller may control the focus distance of the camera C′ when the auto tracking target designator AT is in use because the parallax-computed focus distance of the eye tracker ET can no longer be used. Signals (not shown) from the focusing device (not shown) are sent to the camera positioning device CPD and then to the microprocessor unit MPU. Signals 20, 21, 29 from f-stop F, zoom Z, and run R, respectively, are sent to the microprocessor unit MPU and to the lens LE, and control f-stop and zoom motors (not shown) on camera lens LE. The auto track target designator AT sends signals 52 to video recorder VTR. The video recorder VTR sends signals 33 to monitor MO.

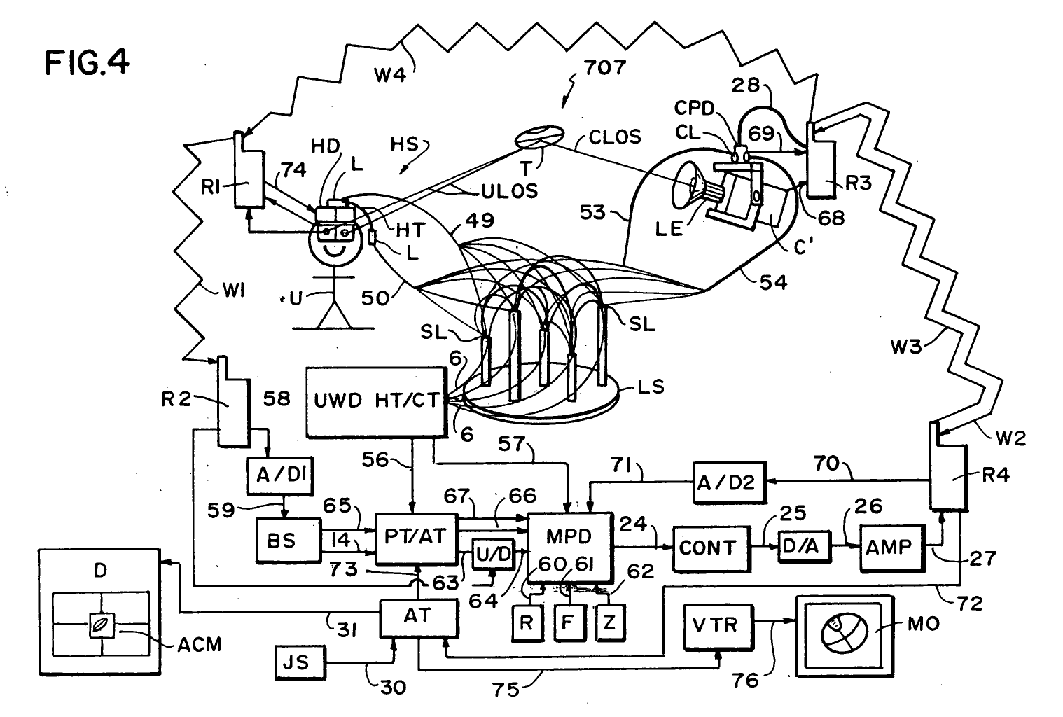

In FIG. 4 the user U may wear a headset HS′ which may have secured thereto an eye tracker ET, a localizer based head tracker HT, and a display HD. The display HD is so constructed (in a well known manner) so as to be capable of being folded into and out of the immediate field of view of a user U. The user's point of regard is tracked by the eye tracker ET. The eye tracker ET sends signals 1 which indicates the point of regard of the user's U look point. The signals 1 is transmitted to the radio transceiver R1. The head tracker HT, which, as previously described, comprises localizers L. The localizers L send signals 49, 50 to stationary localizers SL. Also, as previously described, the localizers SL may be mounted to a localizer stand LS. This localizer system 707 also tracks a camera positioning device CPD via localizer CL mounted on the base (not visible) of the camera positioning device CPD. The localizers CL send signals 53, 54 to the stationary localizers SL. The operation of the system 707 is more fully described in Fleming, et al., and the receiver circuitry UWB HT/CT receives signals 6 from the multitude of stationary localizers SL in the system 707 and may receive signals from localizers L, CL. The receiver circuitry UWB HT/CT tracks the positions of the localizers L, CL, SL and sends tracking data for the head tracker HT and camera tracker CT to the person tracker/auto tracker switch PT/AT and the microprocessor unit MPU via signals 56, 57, respectively. The person tracker/auto tracker switch PT/AT allows the user U to manipulate the camera C′ using either the eye tracker-head tracker ET/HT or the automatic target designator AT. Transceiver R1 sends radio signals W1, which corresponds to signals 1, to transceiver R2. Transceiver R2 sends signals 58, corresponding to signals 1, to the analog to digital converter A/D1 which, in turn, converts the analog signals 58 to digital signals 59.

Limit switches (not shown) in the headset display HD provide position signals for the display HD (sending signals indicating whether the display HD is flipped up or down) and which change modes of focus from eye tracker derived focus to either automatic or manual focus control. When the display HD is up the distance from the user U to the target T may be derived from the signals produced by the eye tracker ET. When the display HD is down, the user U is no longer viewing objects in space. Therefore, another focusing mode may be used. In this mode, focusing may be either automatic or manual. For an example of automatic focusing see Hirota et al.

The run control R controls the camera's operation and the focus control F controls the focus when the user U has the headset mounted display HD in the down position and wishes to operate the focus manually instead of using the camera mounted automatic focusing device (not shown).

Zoom control Z allows the user U to control the zoom. Signals 60, 61, 62 are sent by the run, focus, and zoom controls R, F, Z, respectively. Iris control (not shown) controls the iris of the lens LE. Display position limit switches (not shown) send position signals 36 to the transceiver R1. The transceiver R1 sends signals W1, which include signals 36, to transceiver R2. Transceiver R2 sends signals 78 to a manually positionable switch U/D (such as a toggle switch or a switch operated by a triggering signal from the head set indicative of whether or not the display is activated—not shown) that either allows the head tracker signals 63 to be sent to the MPU via signals 64, when the display HD (which may be, for example, a heads up display or a flip down display) is up and stops the head tracker signals 63 when the display HD is down so that the head tracker signals 63 is used to position the camera C′. When the display HD is up no signals are sent from the automatic focusing device (not shown) or manual focus F and the focus distance is derived from the eye tracker convergence data. When the display HD is down the user U may choose between manual and automatic focus. The zoom control Z may be used when the user U has the display HD up or down and wishes to operate the camera zoom (not shown).

As taught by Smyth, the eye tracker ET signals 59 are sent to the blink switch BS. The blink switch BS receives signals from the eye tracker ET which indicate the time period the user U will not be fixated on a target T because of blinking. The blink switch BS sends the control signals 65 to the person tracker/auto track target designator switch PT/AT for auto track for the period of time that the user U blinks. When the person tracker/auto tracker switch PT/AT is switched to auto track, the switch PT/AT bypasses the eye tracker's and head tracker signals 66, 63, respectively, and signals 67 are sent.

Camera C′ sends its composite video 68 to transceiver R3. The camera positioning device CPD sends signals 69 to transceiver R3. Transceiver R3 sends the radio signals W2, which corresponds to signals 68, 69 to transceiver R4. The transceiver R4 sends signals 70 to analog/digital converted A/D2 that converts analog signals 70 into digital signals 71 that are sent to the microprocessor unit MPU. The microprocessor unit MPU calculates a new point of regard of the camera C′ using tracking data from the eye tracker ET, head tracker HT, and camera tracker CT. The microprocessor unit MPU derives new position signals by comparing the actual position of each of the camera positioning device CPD and lens LE motors to the new calculated position. Signals 24 are sent to the controller CONT which in turn generates control signals 25 and sends it to the digital to analog converter D/A. The digital to analog converter D/A converts the digital signals 25 into the analog signals 26 and sends them to the amplifier AMP. The amplified signals 27 is sent by the amplifier AMP to the transceiver R4. In response to the signals from the amplifier AMP the transceiver R4 sends the radio signals W3 to the transceiver R3. The transceiver R3 receives signals W3 and, in response, sends signals 28 to the camera positioning device CPD. As known in the art, these signals are distributed to the motors which control the camera positioning device CPD and lens LE.

The transceiver R3 sends composite video signals W2, W4 which correspond to the signals 68 from camera C′, to the transceivers R4, R1. The video signals W2, W4 may be radio signals. The transceiver R4, in response to signals W2, sends signals 72 to the auto track target designator AT. As taught by Shnitser et al. The auto track target designator AT tracks images inside a designated portion of the video signals which are controlled by the user U with the joystick JS. The auto track target designator generated signals 73 is sent to the person tracker/auto tracker switch PT/AT, and on to the microprocessor unit MPU via signals 67. The joystick JS signals 30 is sent to the auto track target designator. AT defining the area of concentration for the auto track target designator AT. The auto track target designator AT sends area of concentration ACM signals 31 to display D.

The transceiver R3 sends signals corresponding to video signal 68 to transceiver R1 which sends corresponding video signals 74 to the headset mounted display HD. When the display HD is folded down into the view of the user U, the head tracker HT signals is bypassed. The user U views the scene as transmitted by the camera C′ and only the eye tracker ET controls the point of regard of the camera C′. The user U can also switch off the eye tracker ET, locking the camera's view for inspection of the scene (switch not shown). The auto track target designator AT sends video signals 75 to the video recorder VTR, and the video recorder VTR sends corresponding video signals 76 to the monitor MO.

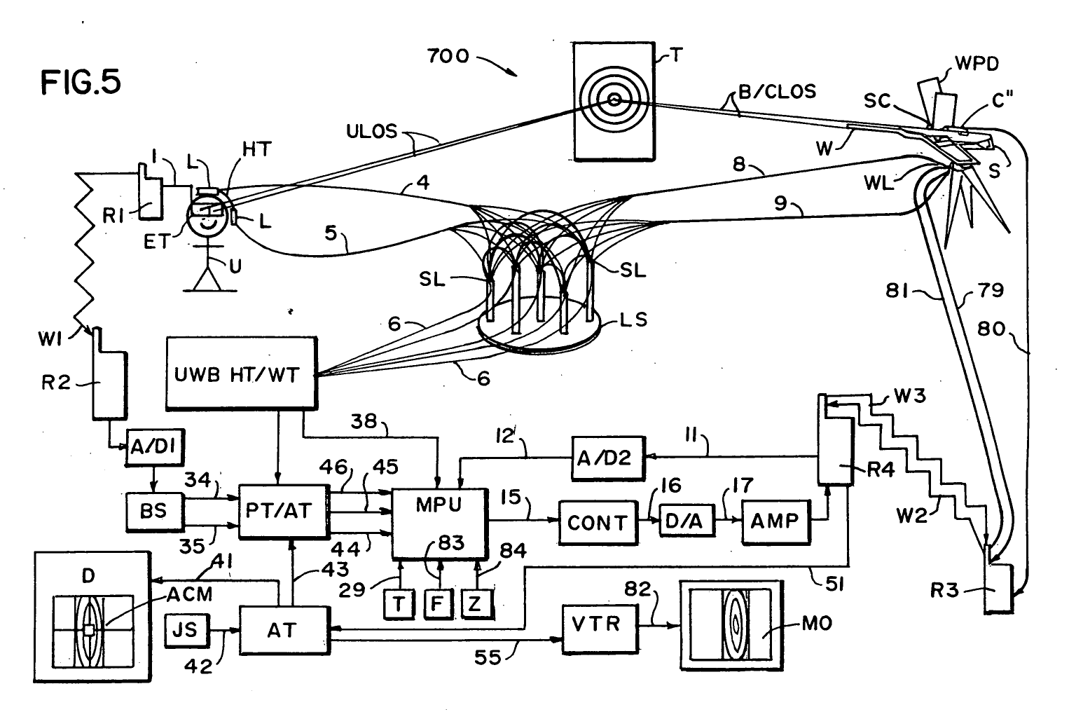

In FIG. 5, user U may wear an eye tracker/head tracker ET/HT equipped headset HS. The eye tracker ET tracks the user's U line of sight ULOS in relation to the user's U view of the target T. The signals 1 from the eye-tracker ET are sent to the transceiver R1. As previously discussed, the transceiver R1 transmits radio signals W1 to transceiver R2. The transceiver R2 sends the signals 2 to the analog to digital converter A/D1 that sends the digital signals 77 to the blink switch BS. The signals 34, which correspond to the signals 2, are sent to the person tracker/auto tracker switch PT/AT.

Another mode allows the user U to blink thereby ET momentarily breaking the control signals sent to the microprocessor unit MPU from the eye tracker ET. Because the eye tracker design by Smyth U.S. Pat. No. 5,726,916) uses electrooculography, the time taken for the user U to blink his eyes and then acquire the target T can be measured. This measurement can be used to switch the person tracker/auto tracker switch PT/AT for the calculated time via signals 35 so that the signals 43 from the auto track target designator AT are sent to the microprocessor unit MPU and the target T is continually and accurately tracked despite the user's blinking activity.

Head tracker HT sends the non-sinusoidal localizer signals 4, 5, the multitude of stationary localizers SL as taught by Fleming et al. A weapon tracker WT, may take the place of the camera tracer CT previously taught herein. It may be of the same design as the head tracker HT and may include localizers WL attached to the base (not shown) of the weapon positioning device WPD. The microprocessor unit MPU may be programmed with the distance (in the X, Y, and Z planes) from the muzzle of a weapon W to the localizers WL so that the weapon W may be aimed. In any application involving a weapon, a laser target designator may be used in place of the weapon W.

The receiver circuitry UWB HT/WT receives signals 6 and sends calculated position data via signals 37, 38 which correspond to the signals from the head tracker HT and weapons localizers WL, to the person tracker/auto tracker switch PT/AT and microprocessor unit MPU, respectively. The weapon positioning device WPD uses motors (not shown) to change the position of the weapon in the X-tilt, Y-pan, and Z-elevation axes of the weapon W.

The weapon positioning device WPD sends signals 79 to the wireless transceiver R3. As taught by Hawkes et al. a camera C″ (or cameras) may be attached to a scope SC and/or the weapon W. The camera C″ sends composite video signals 80 to transceiver R3. Radio signals W2, which corresponds to signals 79, 80 are sent from the transceiver R3 to the transceiver R4. Transceiver R4 receives radio signals W2 and, in response to radio signals W2, sends signals 11 to analog to digital converter A/D2. The analog/digital converter A/D2 converts signals 11 from analog to digital and sends digital signals 12 to the microprocessor unit MPU. The microprocessor unit MPU calculates the user's point of regard using positions of the user's eyes and head as tracked by the eye tracker ET and receiver circuitry UWB HT/WT. The microprocessor unit MPU receives weapon tracking signals 38, which corresponds to signals 8, 9 from the receiver circuitry UWB HT/WT and calculates the point of regard using the encoder positions of the weapon positioning device WPD in relation to the calculated point in three dimensional space of the WPD.

The microprocessor unit MPU compares the actual point of regard of the user U to the actual point of regard of weapon W and attached scope SC. The point of regard of the user U is continually calculated by the microprocessor unit MPU and new position signals 15 for each motor controlling each axis (X, Y, and Z) of the weapon positioning device WPD are sent to the controller CONT. The controller CONT produces signals 16 in response to the signals 15 which are sent to a digital to analog converter D/A. The digital to analog converter D/A converts the digital signals 16 into analog signals 17 and sends these signals 17 to amplifier AMP. The amplifier AMP that produces amplified signals 18 and sends signals 18 to transceiver R4. Transceiver R4 transmits radio signals W3 to transceiver R3. Transceiver R3 receives radio signals W3 and sends signals 81, corresponding to signals 15, to the weapons positioning device WPD and the various motors (not shown) controlling each axis of the weapons positioning device WPD and camera lens (not shown).

Composite video signals 80 from camera C″ are sent to the transceiver R4 from transceiver R3 via radio signals W2. Transceiver R4 sends corresponding signals 51 to the auto track target designator AT. The auto track target designator AT sends signals 41, corresponding to signals 80, to a display D that displays the images taken by the camera C″ as well as an auto track target designator AT created area-of-concentration marker ACM that resembles an optical sight. A joystick JS controls the placement of this marker and may be used without looking at the display. The area-of-concentration marker ACM marks the area of the composite video signals that the auto track target designator AT tracks as the user views the target in space allowing a particular object or target to be chosen. The joystick sends signals 42 to the auto track target designator AT which tracks the object inside the marker of the display D by comparing designated sections of successive frames of the composite video signals and sending new position signals 43 to the person tracker/auto tracker switch PT/AT.

When the person tracker/auto tracker switch PT/AT is switched to auto track target designator AT, signals 34 and 37 from the eye tracker ET and receiver circuitry UWB HT/WT are bypassed and the auto track target designator AT signals 46 corresponding to signals 43 are sent to the microprocessor unit MPU. When the person tracker/auto tracker switch PT/AT is switched to person tracker PT signals 44, 45, corresponding to signals 34, 37, respectively, are sent to the microprocessor unit MPU and the auto track target designator AT signals 46 are bypassed. The AT sends signals 55 to video recorder VTR. The video recorder VTR sends signals 82 to monitor MO.

A focusing device (not shown), as disclosed by Hirota et al. or other manual or automatic may control, focuses the lens of a camera when the auto track target designator AT is in use because the parallax-computed focus distance of the eye tracker can no longer be used. Remote controllers control f-stop and zoom motors (not shown) on camera lens LE. Other controllers (not shown) may be necessary to properly sight in a weapon with respect to windage and elevation. Manual trigger T, focus F, and zoom Z controls send signals 29, 83, 84 to the MPU which processes these signals and sends the processed signals as above.

It should be understood that although only two localizers are shown on the user's head (FIGS. 1-5) and the camera positioning device CPD or the weapon positioning device WPD, there must be at least three localizers.

Another embodiment of the invention includes a limited range, 1 to 10 ft, tracking system used in systems needing aiming, such as weapon systems. U.S. Pat. Nos. 5,510,800 and 5,589,838 by McEwan describe systems capable of position tracking with an accuracy of 0.0254 cm. These tracking systems use electromagnetic pulses to measure the time of flight between a transmitter and a receiver at certain predetermined time intervals. These tracking systems may be used to track the position of the user's head, in the same way as magnetic and optical head trackers, but allow for greater freedom of movement of the user. Using the devices of McEwan eliminates the need to magnetically map the environment and eliminates the effect of ambient light. The disclosures by McEwan are, therefore, included by reference.

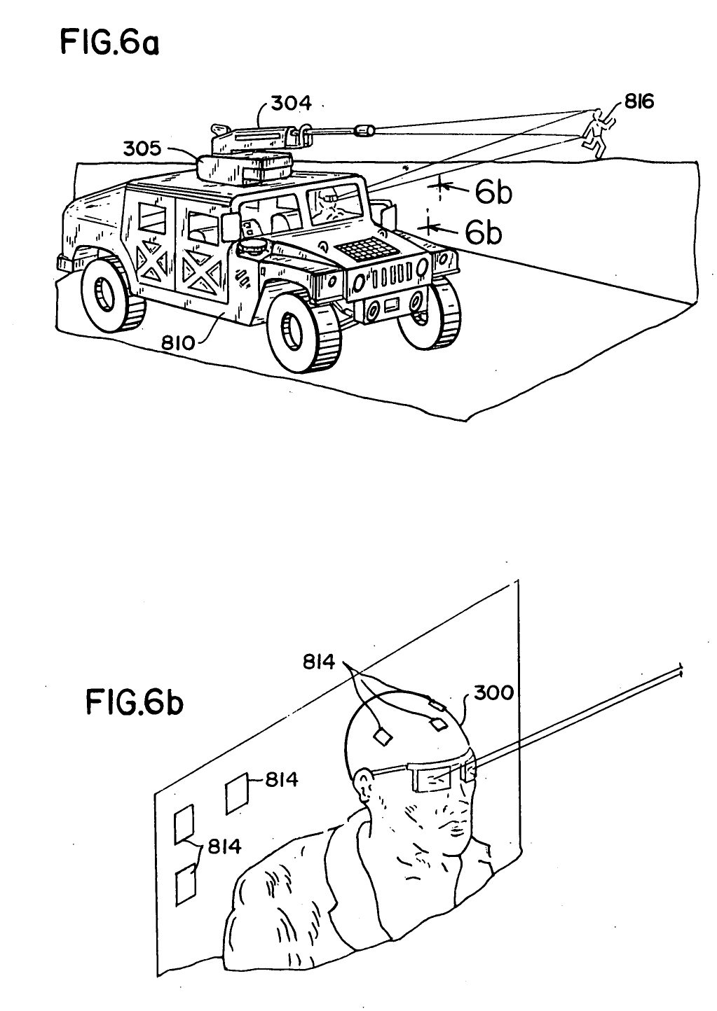

FIGS. 6A and B show a user 300 in a vehicle 810 and an enemy 816. The user 300 is equipped with the head tracker 814 as disclosed by McEwan and an eye tracker ET as disclosed by Smyth and further discussed in connection with FIGS. 1-5 with the accompanying electronics (not shown in FIGS. 6A and B).

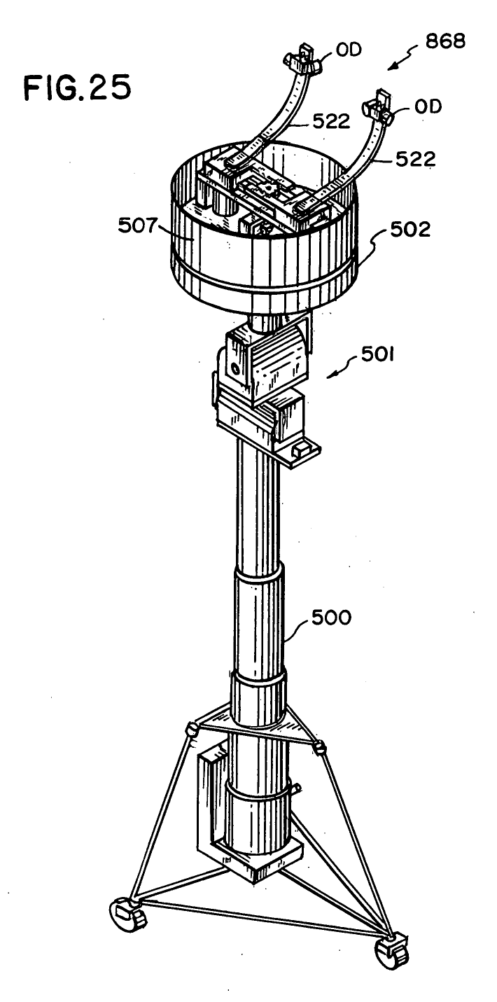

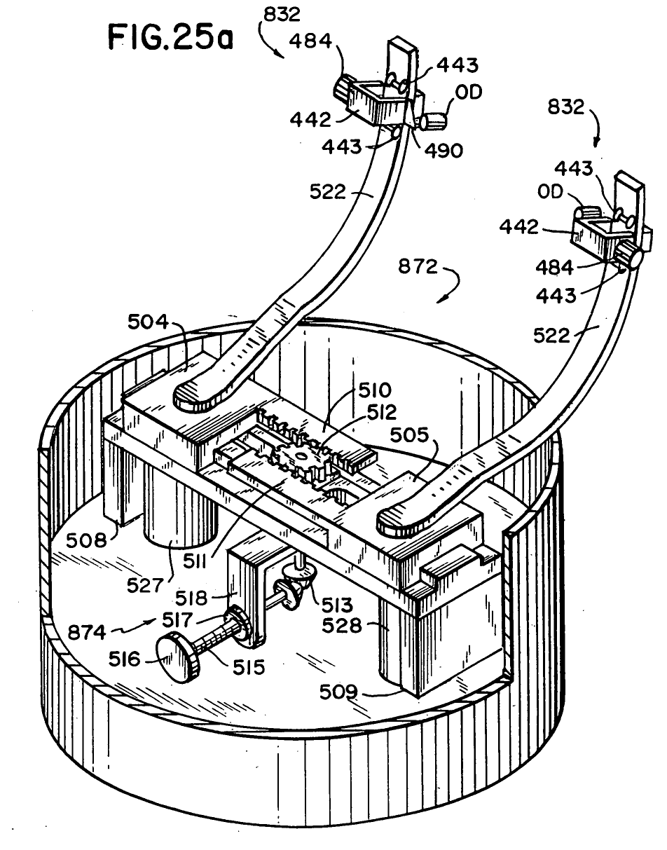

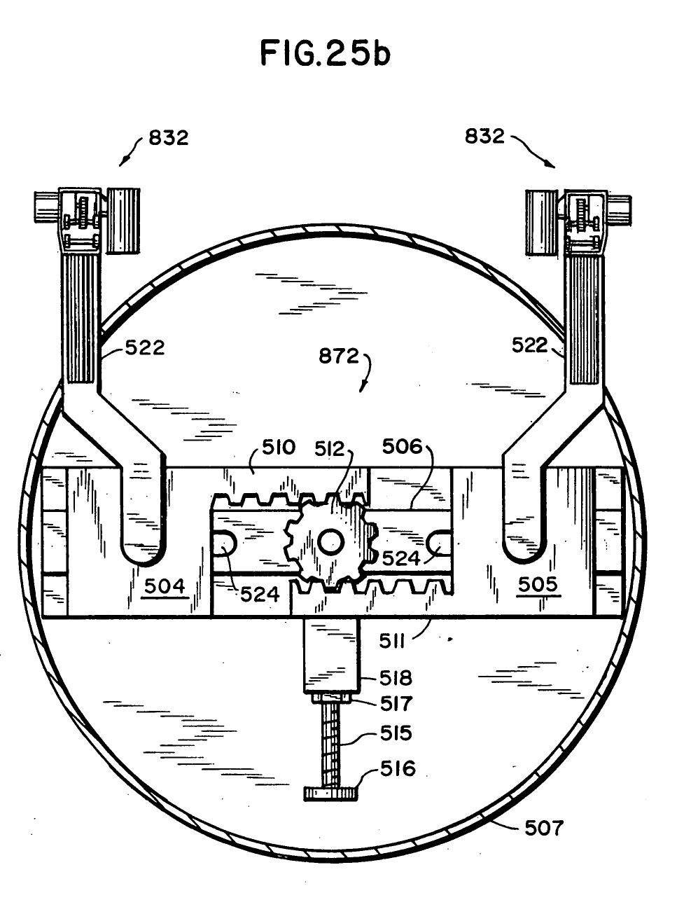

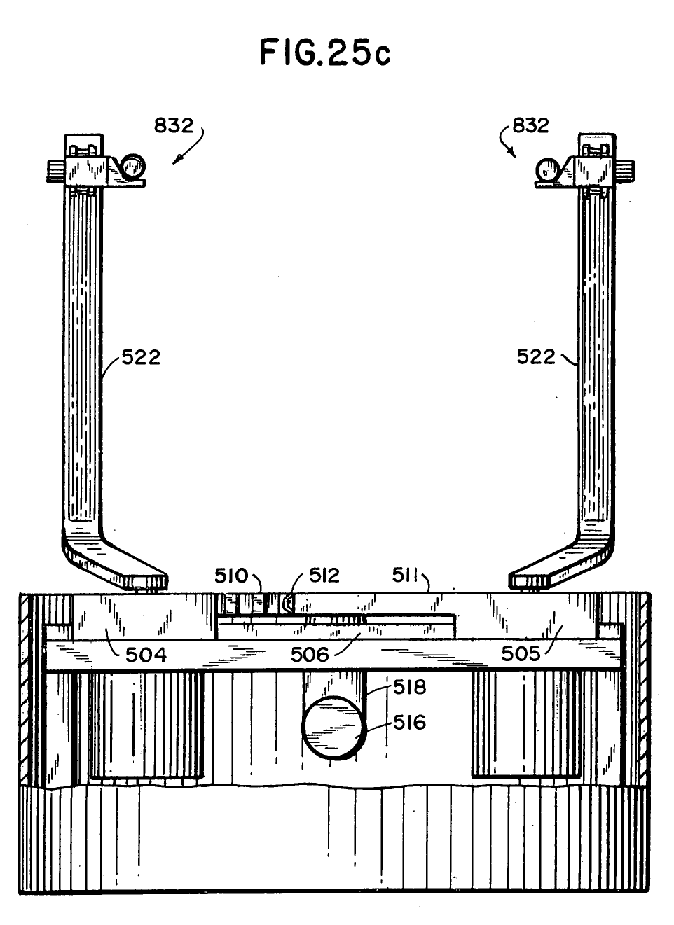

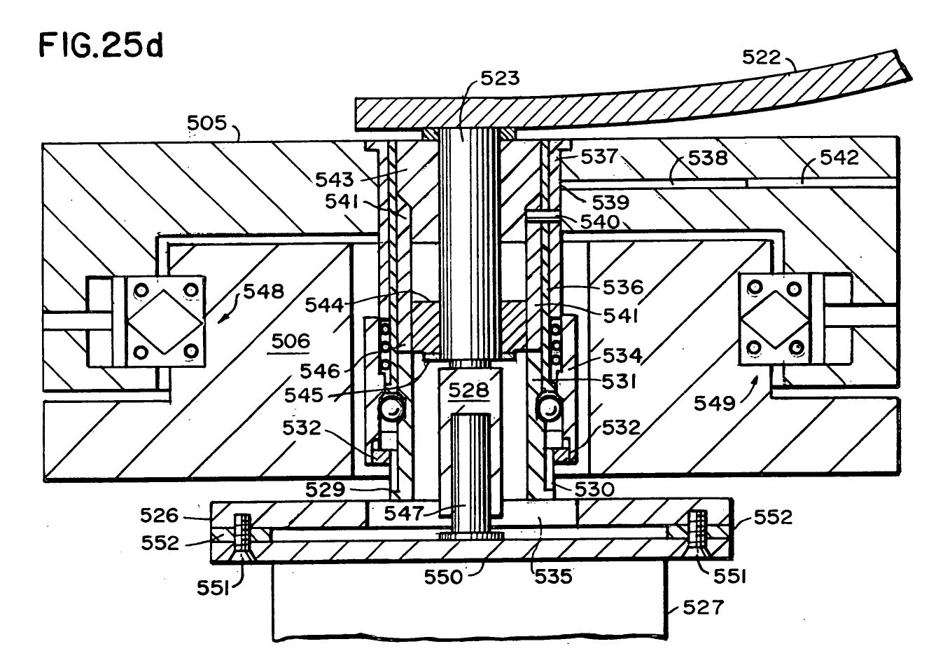

Quinn (U.S. Pat. No. 6,769,347) the disclosure of which is incorporated by reference, discloses a gimbaled weapon system with an independent sighting device. The eye tracker ET and head tracker 814 (the “ET/HT”) can be substituted for the Quinn azimuth and sighting device elevation joystick. The et/ht may track a users look point as he views a monitor inside a vehicle as in Quinn. The eye tracker ET may track the user's eye movements as he looks at a convergence/vertical display as seen in FIGS. 13A, 13B and the data from the eye tracker ET may be used to position a pair of orbital track mounted optical devices mounted to a rotating table 502 (FIG. 25E) that is, itself, may be mounted, as shown in Quinn, to the roof of a vehicle or on the gimbaled weapons system in place of the independent sighting device. Thus, incorporating the teachings of Quinn, the above described arrangement may be adapted for use on many different vehicles and aircraft.

The user 300 views the enemy and signals from the head tracker 814 and eye tracker ET are sent to a computer (not shown but as discussed above) track the user's eye movements as well as his head position to produce correction signals so as to have the tilt and pan head 305 point the weapon 304 at the enemy 816.

A feature of the weapons aspect is the ability to accurately track the user's look point, and aiming of a remote weapon so that the weapon may fire on a target from a remote location. Because the McEwan tracker is usable only within a range of ten feet, one tracker may be used to track the user within ten feet of a tracker, and another tracker may be used to track the weapons positioning device in the remote location. Another tracking system may be used in order to orient the two required tracking systems in relation to each other. By aligning the two high accuracy trackers T1, T2 a target may be fired on by a remote tracked weapon that is viewed by a remote user in another location, as more fully disclosed in FIG. 5 but with more accuracy and greater range.

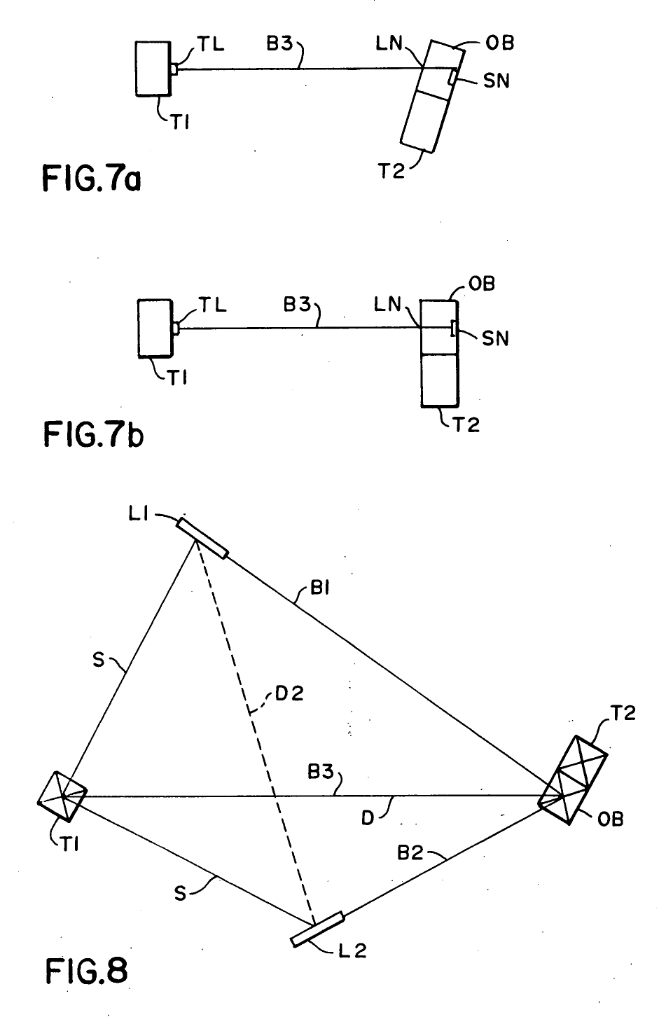

FIGS. 7A-7B show the first tracker T1 which may be equipped with laser TL. The laser TL may be mounted perpendicular to the first tracker T1 in the X and Y axes. The laser TL may be aimed at the optical box OB mounted to a second tracker T2. The optical box OB and second tracker T2 may be positioned in line with a laser beam B3 of the laser TL mounted to the first tracker T1 so that the laser beam passes through the lens LN, which focuses the beam to a point at the distance between the lens LN and the face of a sensor SN which may be mounted to the interior of the optical box OB. When optical box OB is perpendicular to the beam B3 in the X and Y axes, the two trackers T1, T2 are aligned in the X and Y axes. The sensor SN measures the amount of light received. The optical box OB and the attached second tracker T2 are aligned most accurately with the first tracker T1 when the amount of light sensed is at its peak. The centering of the focused beam B3 on the sensor in the X and Y axes accurately aligns the trackers so that they are parallel to each other in both X and Y axis. Hence their orientation in relation to each other in three-dimensional space is the same. The sensor SN may be connected to an audio or visual meter (not shown) to allow a user to position the trackers T1, T2 at the optimal angle with ease. It may be assumed that both the first tracker T1 and second tracker T2 may be mounted to tripod-mounted tilt and pan heads (not shown) that will allow the user to lock their positions down so that once the trackers are both equally level. Second tracker T2 may be aligned with the laser beam B3, and then the distances measured by laser groups L1 and L2 are found and a simple geometry computer model can be produced. FIG. 7A shows the laser beam B3 misaligned with the sensor SN. FIG. 7B shows the laser beam B3 striking the sensor SN after the second tracker T2 is properly orientated.

FIG. 8 shows the first tracker T1 and the second tracker T2. Spacers S of equal dimensions may be mounted to tracker T1 so as to be at a right angle to each other. Mounted to the ends of each of the spacers S may be laser range estimation aids L1, L2, as disclosed by Rogers, U.S. Pat. No. 6,693,702, the disclosure of which is incorporated herein by reference, that are positioned so as to view the optical box OB. Each estimation aid L1, L2 provides multiple laser beams B1, B2 (represented for each as a single line in FIG. 8). The lens LN of the optical box OB may be covered by any well known means such as disk (not shown) after the alignment described above and the cover becomes the target for the estimation aids L1 and L2. The position of the second tracker T2 in relation to the optical box OB is known and compensated for by calculation made by a computer (not shown) using well known geometric formulae. The laser beams B1 and B2 provide a measurement of the distance between the aids L1, L2 and the optical box OB. This, combined with the known distance of the spacers S, may be used to calculate the distance between trackers T1 and T2 using the Pythagorean theorem S²+B1²=D² to produce the distance D equal to the square root of (B1²+S²) from first tracker T1 to second tracker T2, and S²+S²=D2² to produce the distance from L1 to L2 as D2 is the square root of (S²+S²). With the two range aids L1, L2 mounted at points equidistant and at a known angle from the first tracker T1, it is possible to calculate the position in three-dimensional space of second tracker T2 in relation to first tracker T1 using well known mathematical formulae.

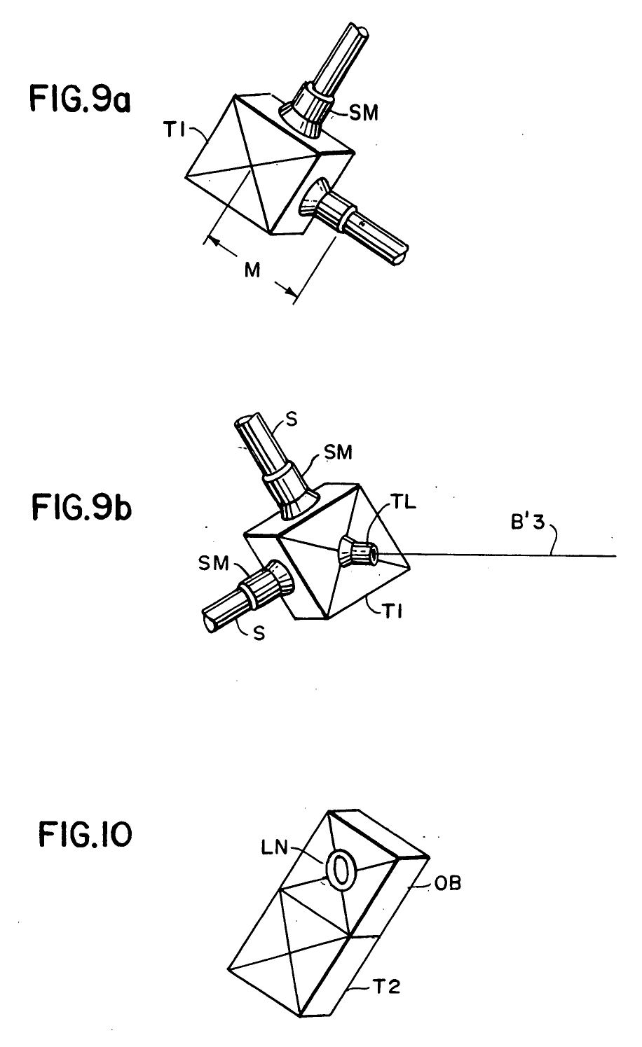

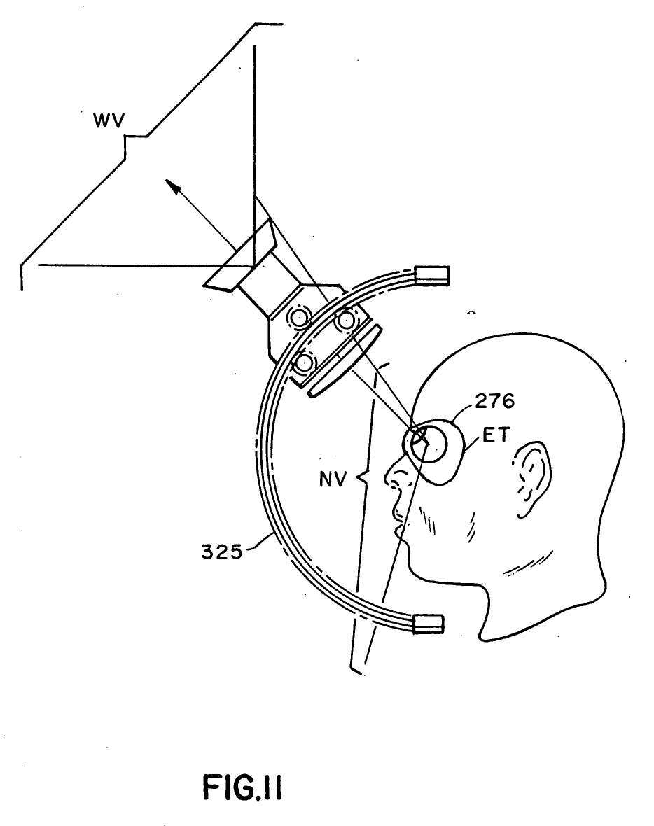

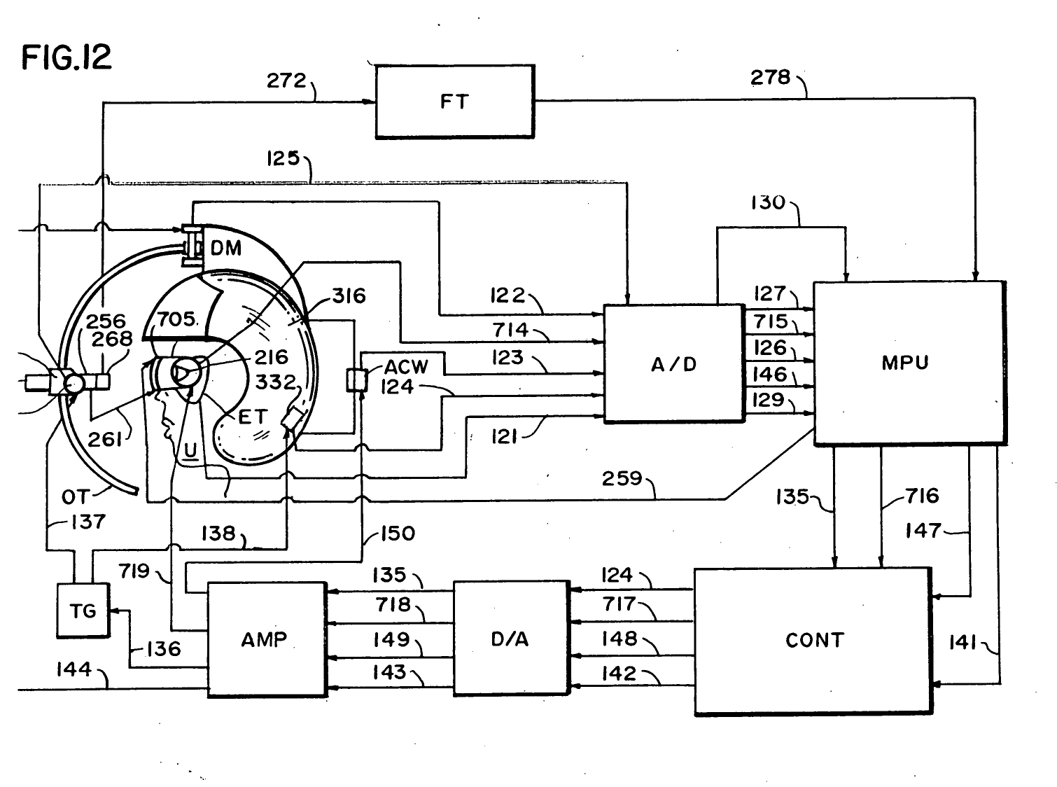

FIGS. 9A and 9B show back and front perspective views of the first tracker T1. Spacer mounts SM are shown. M is the known distance between the center of the first tracker T1 and a known point on the spacer S. Laser TL may be mounted perpendicularly to the first tracker T1 and emits beam B3.

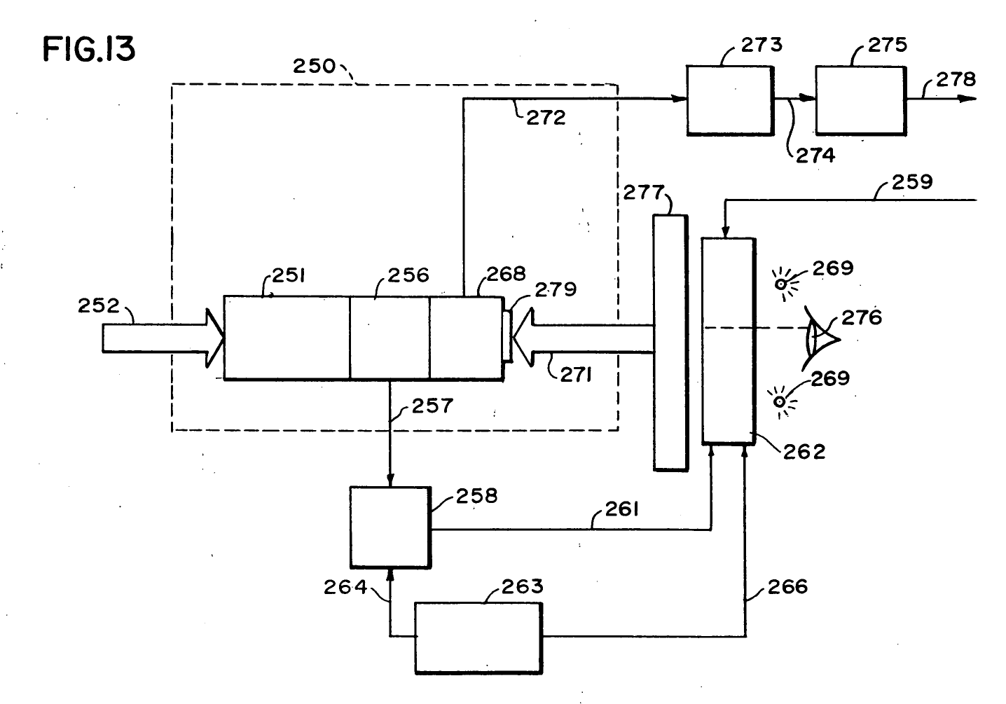

FIG. 10 shows second tracker T2. Lens LN is shown mounted to the optical box OB.

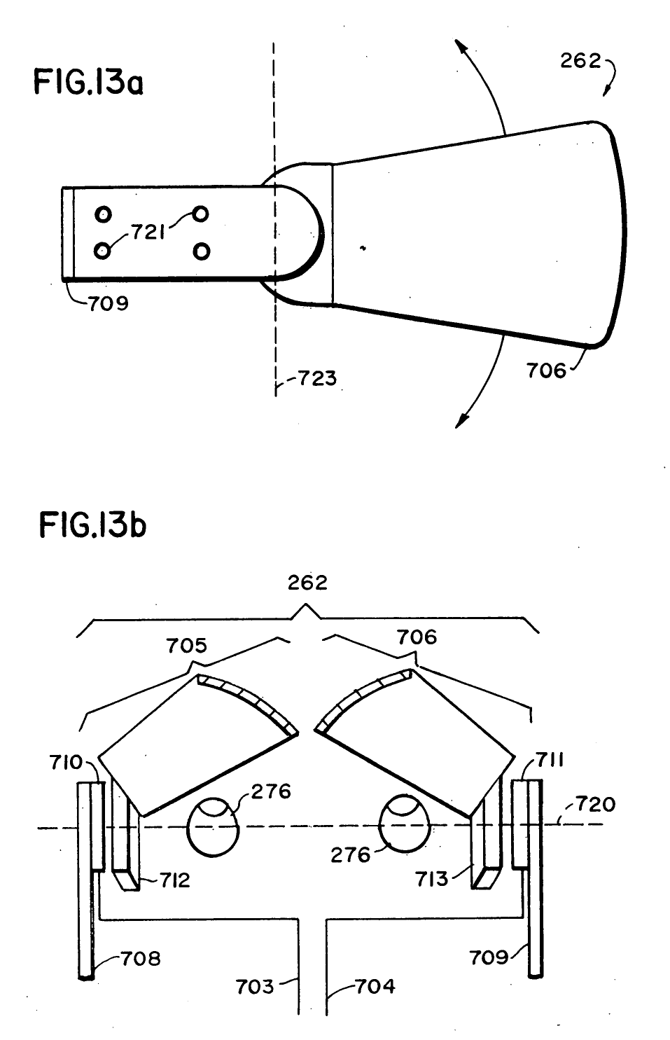

In another embodiment of this invention, eye tracker positioned optical devices may be placed in the direct viewing axis of each of the user's eyes so as to view and/or record the view of each of the user's eyes. FIG. 11 is a schematic view of a user U in relation to orbital tracks 324, 325 (only track 325 may be seen in FIG. 11) having mounted thereon an orbital track carriage OTC and an optical device OD. FIG. 11 shows the normal vertical viewing angles NV and the wider vertical viewing angle WV. The headset is not shown for clarity of viewing angles.

As generally shown in FIG. 11, the field of view of a user U looking straight up may be limited by the user's supraorbital process to approximately 52.5 degrees. The wide-angle collimating optical device disclosed in King et al., U.S. Pat. No. 6,563,638, the disclosure of which is incorporated herein by reference. This device, as shown schematically in FIG. 11, gives a wider range of vision for the user U.

When the device is used in a cockpit of an aircraft or in some other location where it is desired to limit the user's field of vision (as, for example, where part of the field of vision will be taken up by cockpit instrumentation) there may be provided a blinder-type device such as a flexible accordion type rubber gusset or bellows attached to the user's immediate eye wear, i.e., the eye tracker, and may be deployed between the eye tracker and the optical device so as not to interfere with the positioning devices.

Another embodiment of the invention replaces the wide-angle collimating optical devices with a pair of compact video cameras. An stereoscopic active convergence angle display as taught by Muramoto et al. In U.S. Pat. No. 6,507,359, the disclosure of which is incorporated herein by reference, may be combined into the headset so that the user is viewing the surrounding environment through the display as if the cameras and display did not exist. The eye tracker may track the user's eye movements and the user views the surrounding scene as the positioning devices position the camera lenses so as to be pointing at the interest of the user. The display “is controlled in accordance with the convergence angle information of the video cameras, permitting an observer natural images” (Muramoto, Abstract). When used in combination with the orbital positioned optical devices, natural vision may be simulated and may be viewed and recorded.

Because the orbital positioning device mounted cameras are on the same rotational axes as the user's eyes, the parallax of the user's eyes can be used to focus each camera lens. The focus distance must be negatively offset by a distance equal to that of the distance between the lens of the camera and the eye. The focus distance derived from the eye tracker data is computed by the microprocessor unit MPU and a focus distance signals are sent to each focus motor attached to each camera lens mounted on each convex orbital positioning device mount mounted to the headset.

As disclosed, the system may be adopted for one of three uses: as a see-through night vision system, as a head mounted display equipped night vision system, and as a head mounted display equipped camera system with only small adjustments.

In FIG. 12, user U may wear an eye tracker ET and helmet 316 that is fitted with a dorsal mount DM (as more fully described below) and having the orbital tracks OT supporting the optical device OD. Also mounted to the helmet 316 may be an active counter weight system ACW (more fully discussed below). The eye tracker ET sends signals 121, which indicates the position of the eyes in their sockets, to the analog to digital converter A/D. The optical track mount position signals 122 are sent from the dorsal mount DM to the analog/digital converter A/D. Active counterweight position signals 123 are also sent to the analog/digital converter A/D. X-axis position signals 124 are sent from the X-axis motor 332 to the analog/digital converter A/D. Y-axis position signals 125 are sent from the Y-axis motor 484 to the analog/digital converter A/D. The analog/digital converter A/D sends digital signals 126, 129, and 130 corresponding to signals 121, 124, and 125 to the microprocessor unit MPU which then calculates the error between the measured optical axes of the user and the actual optical axes of the optical device and sends error signals 133 to the controller CONT. The controller CONT receives the error signals 133 and, in response, sends control signals 134 to the digital to analog converter D/A that, in response, sends signals 135, corresponding to signals 134, to the amplifier AMP Amplifier AMP amplifies signals 135 and sends the amplified signals 136 to the eye tracker control toggle switch TG, allowing the user U to turn off the movement of the optical devices so as to be able to look at different parts of an image without changing the position of the optical devices.

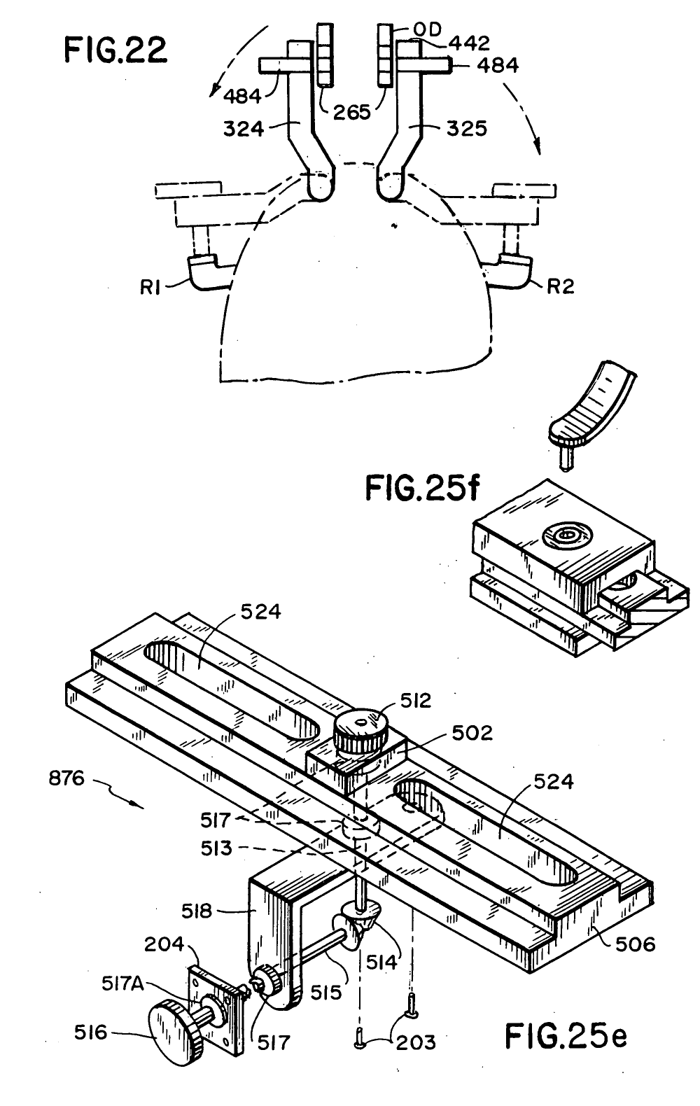

In night vision aviation, for example, a pilot may wish to keep a target, such as another aircraft, in view while looking at something else. The user U may use an auto track target designator as described above (FIGS. 2-5) to track the object inside an area of concentration set by the user U. This could be used in conjunction with the blink switch BS, also described above. Another switch (not shown) could send signals to the microprocessor unit MPU that would send signals corresponding to measured positions of the orbital tracks so as to be swept back as close to the helmet as possible. Rubber spacers R1, R2 are attached to the helmet 316 on either side to allow the orbital trackers 324, 325 to remain there without bumping into the side of the helmet 316 and damaging the carriages or the optics mounted on the outside when the tracks are in there swept back positions (see FIG. 22).

Signals 137 and 138, sent from toggle switch TG when the toggle switch TG is on, are sent to the Y and X axes motors 484 and 332, respectively, that position the OD(s) independently so as to always be substantially at zero degrees in relation to the optical angle of each eye. A micro camera 268 receives light reflected from the user's face and converts it into an electrical signals that are sent to the face tracker FT. Video signals 272 are sent from the micro camera 268 to the face tracker FT that sends position error signals 278 to the microprocessor unit MPU. The microprocessor unit MPU calculates the error between the position of the user's eye(s), in relation to the position of the orbital track mounted optical device so as to keep the optical device in-line with each of the user's eyes. The microprocessor unit MPU also sends signals 259 representing convergence angle information of the optical devices OD to the head mounted and convergence display 262.

The active orbital mount motors or actuators 333, 327, 326 adjust the device by identifying facial landmarks of or nodes on the user's face and processing the data to as disclosed in Steffens et al., U.S. Pat. No. 6,301,370, the disclosure of which is incorporated herein by reference. One or two small cameras 268 may be mounted on the orbital track carriage OTC and pointed at the user's face to provide images (and, where two cameras are used, a 3D image) to the tracker FT. The optimum angle of the line of sight in reference to the optical axis of the camera is zero degrees. In order for the camera/optical device to be positioned to the point at which the optimal angle is achieved, the active mount motors or actuators 333, 327, 326 tracks the user's actual eye position in relation to the user's face and the known position of the mounted main optical device OD. The images are used to calculate a new position for the single vertical and dual horizontal members of the active mount motors or actuators 333, 327, 326.

In the case of systems with displays, the face tracker FT can measure nodes on the user's U face to measure the displacement from the center of a face-capturing micro camera 268 that may be mounted to the orbital track carriage OTC and centered in-line with the optical device (see FIG. 13) and is offset in the case of see-through systems. The microprocessor unit MPU may calculate the position error and sends these signals 141 to the controller CONT. The controller CONT receives the correction signals 141 and, in response, produces control signals 142 which are sent to the digital to analog converter D/A that converts the digital signals to analog signals 143 which, in turn, are sent to the amplifier AMP. The amplifier AMP, in response, sends amplified signals 144 to the active mount motors or actuators 333, 327, 326 (see FIGS. 16A-18F).

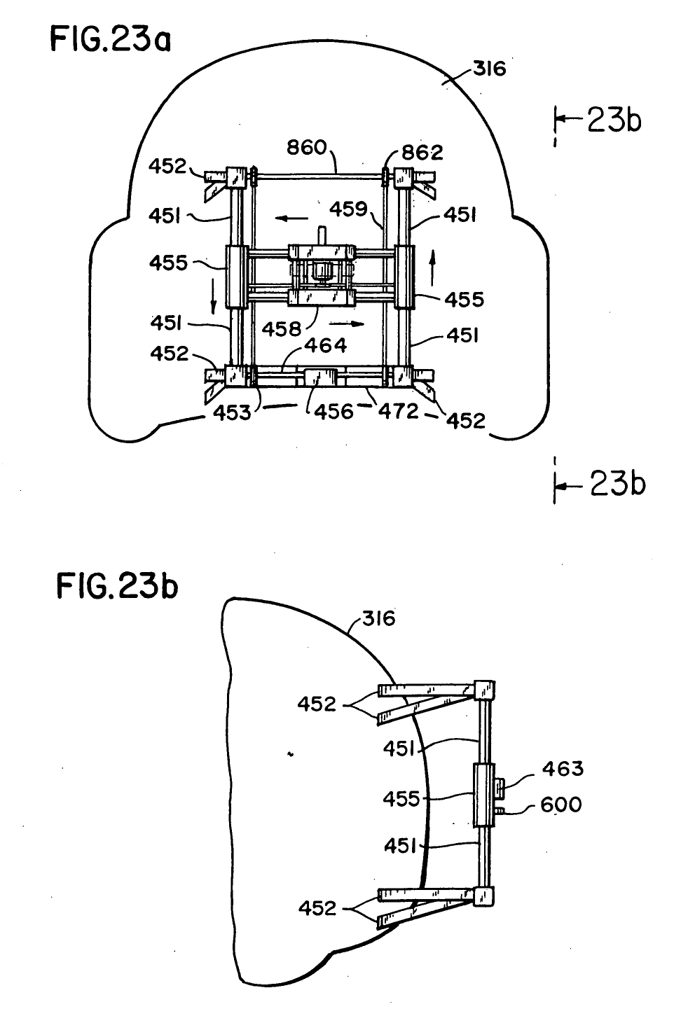

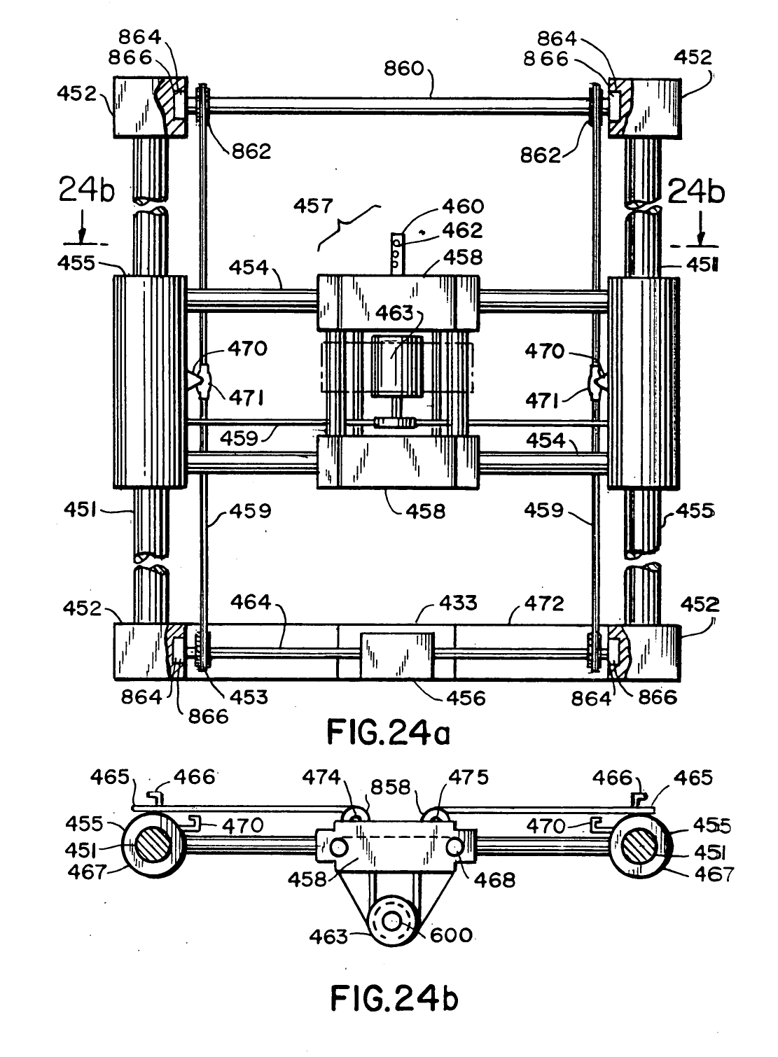

Active counterweight encoders (not shown) on the motors (discussed with reference to FIGS. 23, 24) send signals 123 to the analog/digital converter A/D which converts the analog signals to digital signals 146 and sends them to the microprocessor unit MPU. From the signals received, the microprocessor unit MPU calculates a new position of the active counterweight ACW using known moment data derived from the eye tracker data which the microprocessor unit MPU calculates using the mass of the orbital tracks OT and counter weight (not shown) as well as the acceleration, distance, and velocity of the eye-tracker-measured eye movement, the result of which is provided as signals 147. The microprocessor unit MPU sends signals 147 to the controller CONT. The controller CONT, in response to signals 147, sends control signals 148 to the digital to analog converter D/A which converts the digital signals into analog signals 149 and sends them to an amplifier AMP which, in turn, amplifies the signals corresponding to the signals 147 as signals 150 which are, in turn, transmitted to the active counterweight motors ACW.

The device by Muramoto et al. uses convergence angle information and image information of video cameras which are transmitted from a multi-eye image-taking apparatus, having two video cameras, through a recording medium to a displaying apparatus. A convergence angle of display units in the displaying apparatus is controlled in accordance with the convergence angle information of the video cameras. In this invention, the Muramoto display system 262 (FIGS. 12, 13, 13A and B) is mounted to rotate vertically about the center of the user's eyes 276 (FIGS. 13A and B), so as to provide a realistic virtual visualization system that provides images which are concurrent with the images captured by the dual orbital track mounted optical devices OD (FIG. 12) mounted to the helmet 316 to give the user U a realistic view of a scene.

Eye tracker-tracked eye position signals 259 are sent from the microprocessor MPU to the head mounted and convergence display 262. Vertical head mounted displays position signals 714 are sent to the analog to digital converter A/D. The digital converter A/D converts the received analog signals to digital signals 715 and sends signals 715 to the microprocessor unit MPU. The microprocessor unit MPU compares the actual position of the eyes 276, in the vertical axis 723, as tracked by the eye tracker ET, to the vertical positions of the head mounted and convergence displays 262. Each part 705 (FIG. 12) and 706 of the head mounted and convergence display 262 (FIGS. 13A and 13B) is positioned by a respective motor 710 and 711 (FIGS. 13A and 13B) (only motor 710 is visible in FIG. 12). The two independent head mounted displays 705 and 706 are mounted to the helmet 316 via support arms 708 and 709. Fasteners 721 attach the supports 708, 709 to the helmet 316, not shown in FIG. 13B. The MPU sends error signals 716 to the controller CONT which, in turn, produces control signals 717 to the digital to analog converter D/A that, in turn, converts the digital signals to analog signals 718 and sends analog signals 718 to the amplifier AMP. The amplifier AMP amplifies the signals 718 and sends the amplified signals 719 to vertical axis motors 710, 711. The vertical motor signals 703, 704 of motors 710, 711, respectively, are paired into signal 719 (FIG. 13B). Each half of the display 705, 706 of the head mounted and convergence display 262 is positioned independently, and hence is controlled by separate signals 703, 704. User's eyes 276 are bisected by horizontal eye centerline 720, that is also the centerline of the drive shafts (not visible) of direct drive motors 710 and 711. Display mounts 712 and 713 structurally support the displays 705, 706 and are attached to output shaft of motors 710 and 711, and by set screw in threaded bore (not shown) pressing against the flat face of motor output shaft (not shown) which keeps them in place in relation to the motor output shafts, support arms, and the helmet 316.

The orbital track carriage OTC mounted optical device group 250 may ride the orbital tracks 324, 325 (FIG. 13). This may consist of a optical device 251 having a sensor 256. The optical device 251 may be, by way of example, a visible spectrum camera, a night vision intensifier tube, a thermal imager, or any other optical device. Ambient light 252 may enter and be focused by the optical device 251 so as to be received by the sensor 256. The sensor 256 converts the optical signals into video signals 257 that are then sent to an image generator 258. The image generator 258 receives the video signals 257 and adds displayed indicia (e.g., characters and imagery) and produces signals 261 which is transmitted to the head mounted and convergence display 262, as disclosed Muramoto et al., so as to be viewed by the user's U eyes 276. There may be provided a synch generator 263 which synchronizes the image generator 258 with the head mounted and convergence display 262 using signals 264 and 266. The signal on signal 259 received by the head mounted and convergence display 262 is the eye tracker data derived convergence angle signals which goes to both sides 705, 706 of the head mounted and convergence display 262. The signal on signal 259 is sent by the microprocessor MPU and is indicative of the convergence angle of the eyes to the head mounted and convergence display 262 (FIGS. 12 and 13).

The devices (i.e., the orbital track motors 332, 334, orbital track carriage motors 484, convergence display actuators (by Muramoto et al.), and vertical display motors 710, 711), which are the devices which rotate about the user's U head/helmet in reaction to the movement of the user's U eyes, should operate in conjunction with each other and with as close to the same rate as the motion of the user's U eyes as possible. Because each device has a slaving lag, as is well known in the art, and these lags are known to be measurable, the lags can be compensated for by the microprocessor MPU. Thus, the microprocessor MPU may be programmed to send different signals to the controller CONT at different times so as to compensate for the lags to thereby synchronize all of the devices to eliminate any differences in movement Thus, the microprocessor unit MPU sends signals 141, 133, 716, 147 to the controller CONT and signals 259 are sent to the head mounted and convergence display 262. Signals 141 are the active mount control signals for controlling the motors or actuators 327, 326, 333 that support the orbital tracks; signals 133 are the optical device control signals; signals 716 are the vertical head mounted display control signals; and signals 147 are the counterweight control signals.

Near infrared LEDs 269 (FIG. 13) emit near infrared light towards the user's U face. Near infrared light 270 reflects off the user's U face and travels through the display and transmits through LED frequency peaked transmittance filter 277 that blocks a substantial portion of all visible light (such filters are well known in the art). This invention is also applicable to filters which can switch on and off, selectively blocking and allowing visible light to pass.

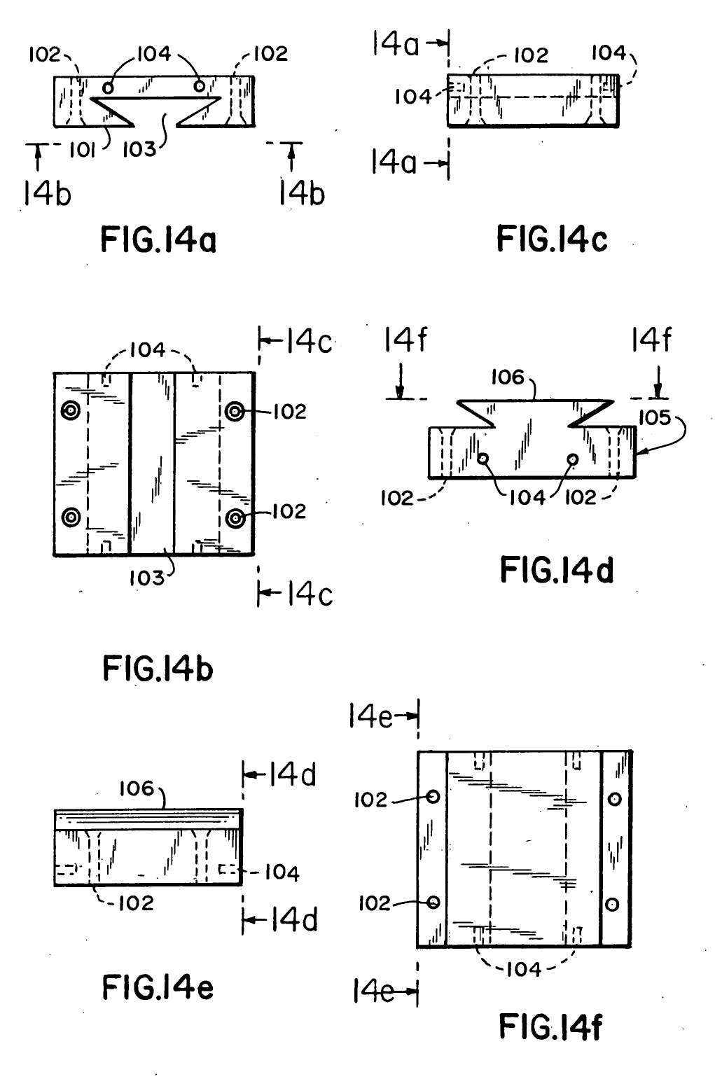

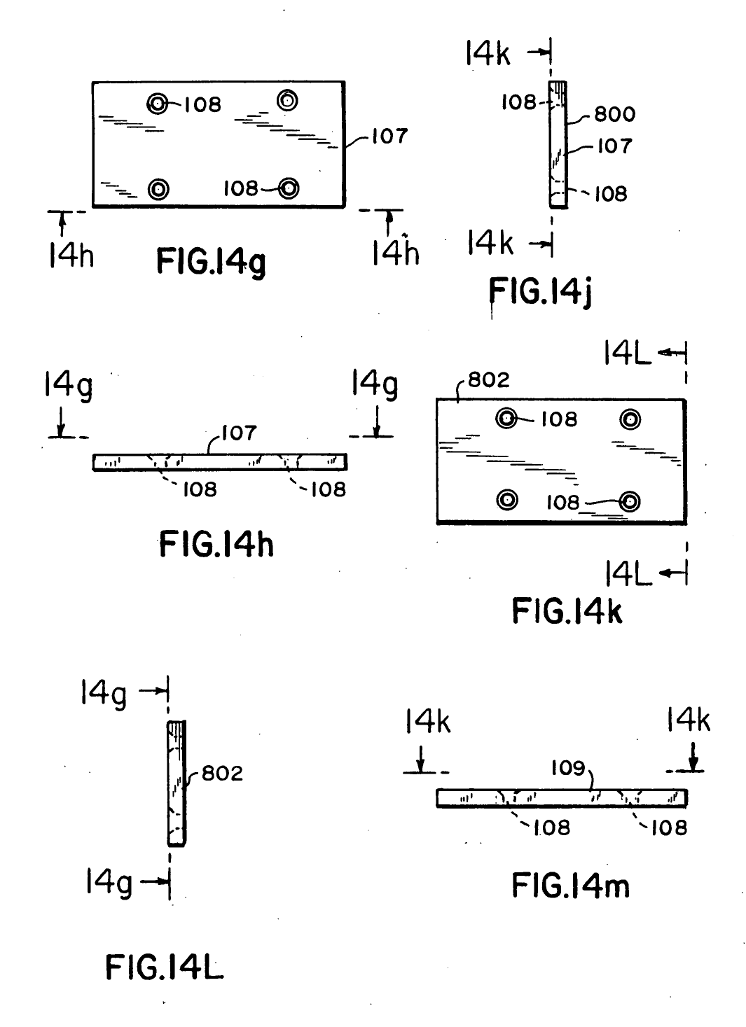

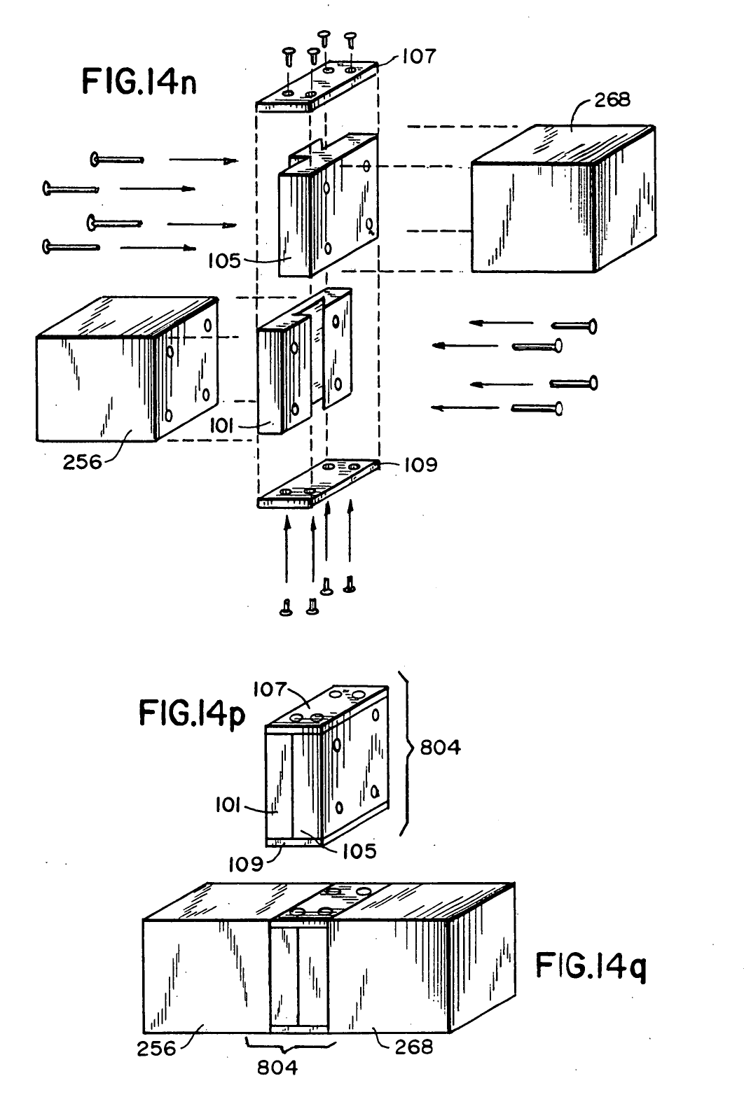

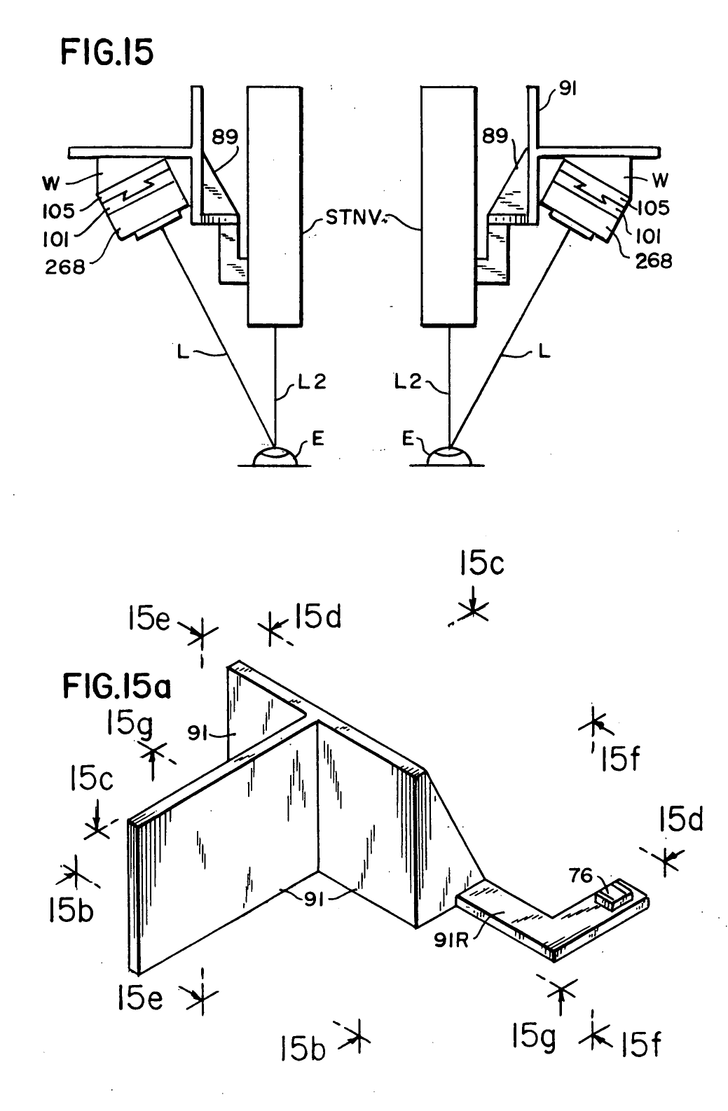

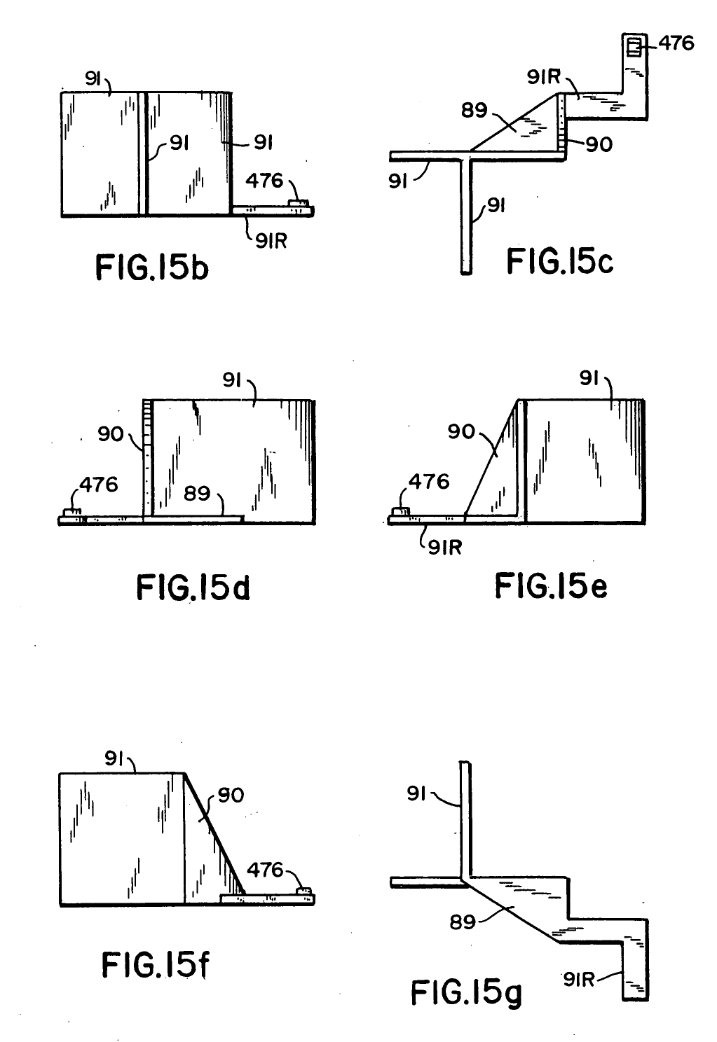

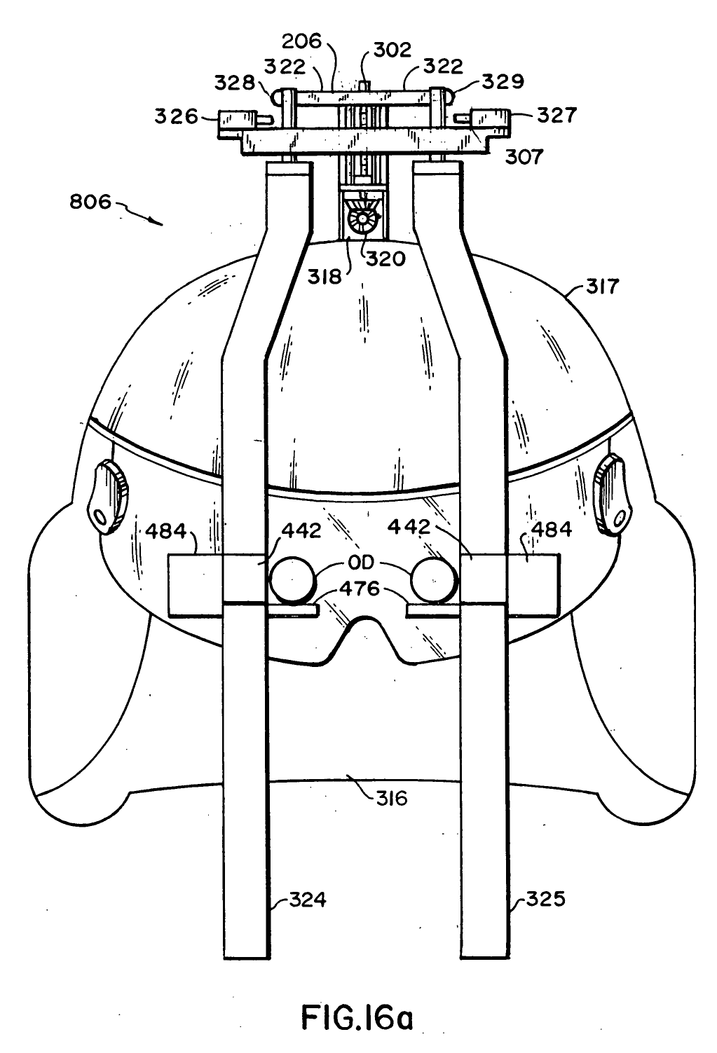

A filtered light beam 271 continues through a LED frequency transmittance peaked protective lens 279 into an LED frequency peaked camera 268. This camera 268 is not only viewing light reflecting off the user's U eyes, as is known in the art of eye tracking, but is, also, viewing light reflected off the user's face and eyes 276. An image of the eyes and the face is captured by the camera 268. In the case of systems with displays, the camera 269 may be mounted in such a way so that the center of the optical plane may be aligned with that of the mounted optical device and offset in see-through systems. Because the camera 268 and, hence, the optical track carriage OTC, is mounted via mounting structure to the optical device 251, 256 (FIGS. 14A-E), if the optical device 251, 256 is out of alignment, the camera 268 will be out of alignment.

The camera signals 272 are sent to a face tracker image processor 273 and then to a face tracker 275 via signals 274. The face tracker sends signals 278 to the microprocessor unit (not shown in FIG. 13) are used to derive correction signals which are derived from the face tracker signals and the mount position signals (not shown). Using the face tracker, as disclosed in Steffens et al. (U.S. Pat. No. 6,301,370), the disclosure of which is incorporated herein by reference, points of a user's face can be tracked “faster than the frame rate” (Id., at column 4, line 12). “The face recognition process may be implemented using a three dimensional (3D) reconstruction process based on stereo images. The (3D) recognition process provides viewpoint independent recognition” (Id. at lines 39-42). The face tracking, or more importantly the position of the eye, relative to the position of the orbital track carriage mounted optical device may be used to produce error signals for the active mount motors or actuators. This can be corrected in real-time to produce an active mount thereby reducing the need for extremely precise and time consuming helmet fitting procedures.

The technology of the system disclosed in FIGS. 12-13 can be used in the tracking system of this invention and can be used in other setting. For example, and without limitation, this system may be useful in optometry for remotely positioning optical measuring devices.

In another embodiment, the image input to the displays 705, 706 from cameras or any optical device may be replaced by computer generated graphics (as, for example, by a video game, not shown). In so doing, the system provides a platform for a unique video game in which the game graphics may be viewed simultaneously on two displays which, together, replicates the substantially correct interpupilary distance between the eyes to thereby substantially replicate three dimensional viewing by allowing the user to look up and down and side-to-side while the system generates display information the appropriate to the viewing angles. In this embodiment the orbital system and cameras are eliminated. The two views are provided to each half of the head mounted and convergence display 262 by the graphics generator portion of the game machine/program.

In FIG. 14A, a female dovetail bracket 101 may be seen from the top, front, and side. The bracket 101 may be mounted to the back of the main optical device sensor 256 which may be machined to receive fasteners (FIG. 14E1) at points corresponding to countersunk bores 102. The bracket 101 accepts a male dovetail bracket 106 (FIG. 14B), via machined void 103. Upper and lower bracket retention covers 109, 107 (FIGS. 14C, 14D) may be secured to the female dovetail bracket 101 with fasteners threaded into threaded bores 104.

In FIG. 14B, the male dovetail bracket 105 can be seen from the top, front, and side. Male dovetail member 106 which mates to female void 103 can be seen.

In FIG. 14C the upper bracket retaining cover 107 can be seen from the top, front, and side. Cover 107 may be machined to the same width and length as the mated brackets 101, 105. Countersunk bores 108 may be equally disposed on the face 800 of the cover 109 and are in positions that match bores 104 in brackets 101, 105 when positioned on the top of the brackets.

In FIG. 14D the lower bracket retaining cover can be seen from the top, front and side. Plate 109 is machined to be of the same width and length of the mated brackets 101, 105 when they are fitted together. Countersunk bores 108 are equally placed on the face 802 of the cover 109 and are in positions that match bores 104 in the mated brackets 101, 105.

FIG. 14E1 is an exploded view of the mated parts of the dovetail bracket 101, 105, bolted to each respective back to back sensors 256 and 268, and kept in place by upper and lower retaining covers 107, 109.

In FIG. 14E2 the covered dovetailed bracket 804 may be seen without the back-to-back sensors attached.

In FIG. 14E3 the covered dovetailed bracket 804 can be seen with the back-to-back sensors 256 and 268 attached.

In order to constantly track nodes on the user's face, and thereby track the user's eye placement in relation to the user's face, the user's face must be constantly monitored by cameras. The face-capturing camera 268 may be mounted on the same optical axis as the main, outward facing camera or optical device OD. However, in night vision the cameras should be offset so as to not block the forward vision of the user. When the see-through version is used, the face-capturing camera cannot be back-to-back with the outward facing see-through device (as in FIG. 14E3) because the user must look through the see-through device. Therefore, the face-capturing camera must be offset so as to not interfere with the user's line of sight through the see-through night vision devices.

In FIG. 16A, the front view of the helmet mounted orbital positioning device 806 is shown. The helmet 316 may be equipped with visor 317. The dorsal mount 318 (identified as DM in FIG. 12) may be centered on the top of the helmet 316 so as to be clear of the visor 317. A horizontal support member 301 may be attached to the dorsal mount 318 by guide shafts 303 and threaded linear shaft 302. Horizontal support member 301 may be attached to the front face 812 of the dorsal mount 318 by way of a machined dovetail mate (not shown) to provide greater rigidity. The horizontal support member 301 travels up and down on the guide shafts 303, driven by the threaded linear shaft 302, which may be held in place by dorsal mount mounted thrust bearings 19A and 19B so as to rotate about its vertical axis as it is driven by a miter gear pair 320.

The horizontal member 818 of the miter gear pair 320 may be mounted to a male output 820 of a flexible control shaft 321, which may be mounted to the dorsal mount 318 and runs through the bored center (not shown) of the dorsal mount 318 to the rear of the helmet 316 (FIGS. 16B-17). The horizontal support member 301 supports and positions the orbital tracks 324 and 325 which are, in turn, mounted to thrust bearings 330. The pair of thrust bearings 330 are mounted to crossed roller supported mounts 4A and 4B. Mini linear actuators 326, 327 provide accurate lateral position control to the crossed roller supported mount 4A, 4B, and, hence, the lateral position of the orbital tracks 324, 325. The mini linear actuators 326, 327 may be mounted to flange platforms 4C, 4D. Flexible control shafts 322, 323 may be mated to right angle drives 328, 329, respectively, which are, in turn, mated to the orbital tracks 324, 325 to provide rotational force to each orbital tracks mast 338, 339, respectively. Flanged thrust bearings 330, 331 may fit into supported mounts 4A and 4B, respectively, to provide a rigid rotational base for each orbital track mast 338, 339, respectively (FIG. 20). shows this arrangement in detail.

FIG. 16B shows the side view of the helmet mounted orbital positioning device 806. Drive components 332, 333 may be mounted at the rear of the helmet mounted orbital positioning device 806 to offset the weight of the frontal armature 822. Flexible control shafts 321, 322 and 323 can be seen along the top of the dorsal mount and inside it. A hole 205 in the dorsal mount under the top ridge that supports flexible control shafts 322 and 323 may provide the user a handle with which to carry the unit.

FIG. 16C shows the rear view of the helmet and the rear retaining mount 335 to which drive components 332, 333 and 334 are mounted. Rear retaining mount 335 also provides panel mount flexible control shafts end holders (now shown) so as to provide a rigid base from which the drive components can transmit rotational force. The drive components are shown with universal joints 336 and 337 attached to drive components 332 and 334, but any combination of mechanical manipulation could be used. The drive components are servo motors with brakes, encoders, tachometers, and may need to be custom designed for this application.

FIG. 16D shows the top view of the helmet, especially the flexible control shafts 322, 323. A fitted cover made of thin metal, plastic or other durable material may be attached to the rear ¾ of the top of the dorsal mount to protect the flexible control shafts pair from the elements.

FIG. 17 shows a side detailed view of the dorsal mount without the horizontal support member for clarity. The upper retaining member 206 retains thrust bearing 19A which retains threaded linear shaft 302. It screws down to the top of the dorsal mount 318 (fasteners and bores not shown) and allows for removal of the horizontal support member. Linear thruster tooling plate 207 (of the type of four shaft linear thruster manufactured by, for example, Ultramation, Inc., P.O. Drawer 20428, Waco, Tex. 76702—with the modification that the cylinder is replaced by a threaded shaft which engages a linear nut mounted to the housing), is mounted to dorsal mount flange 208 (fasteners and bores not shown). Triangular brace 209 supports dorsal mount flange 208 as well as providing cover for gears 20, which are enclosed to keep clean. Screw down flange 210 mounts the dorsal mount to the helmet 316.

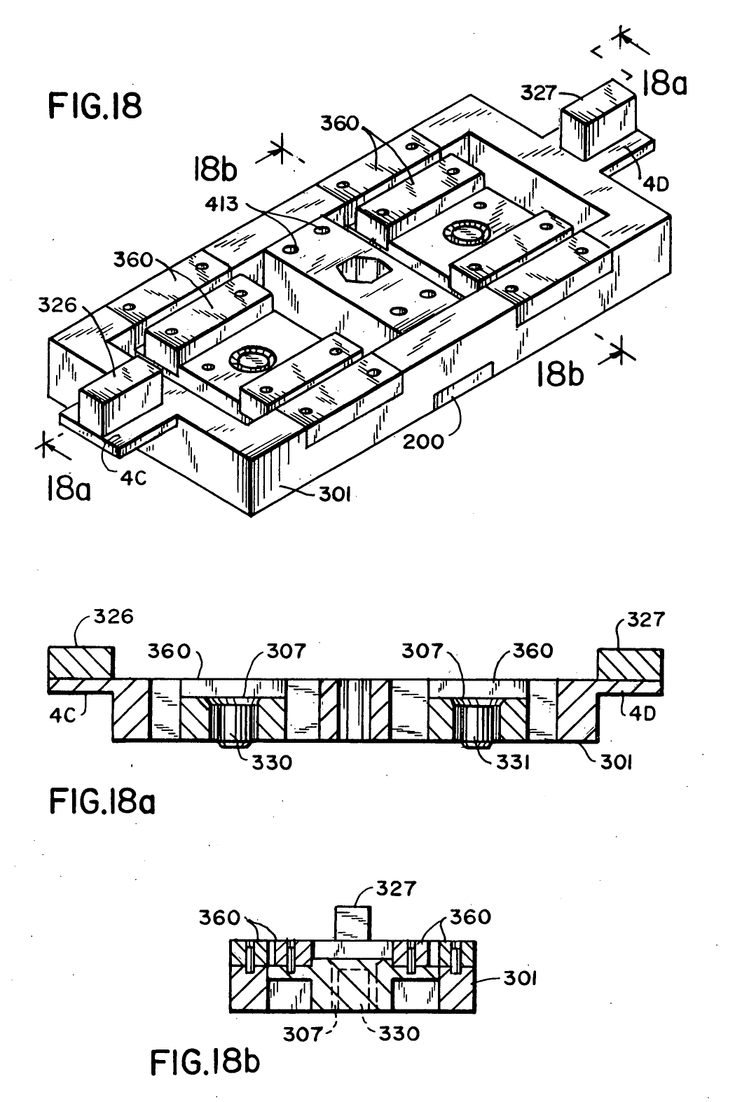

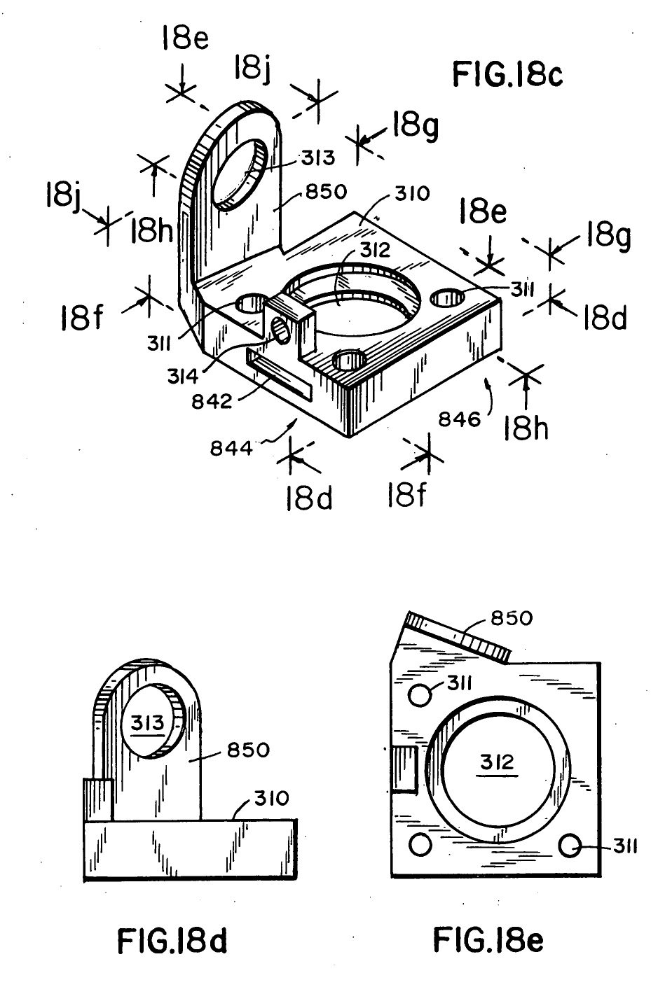

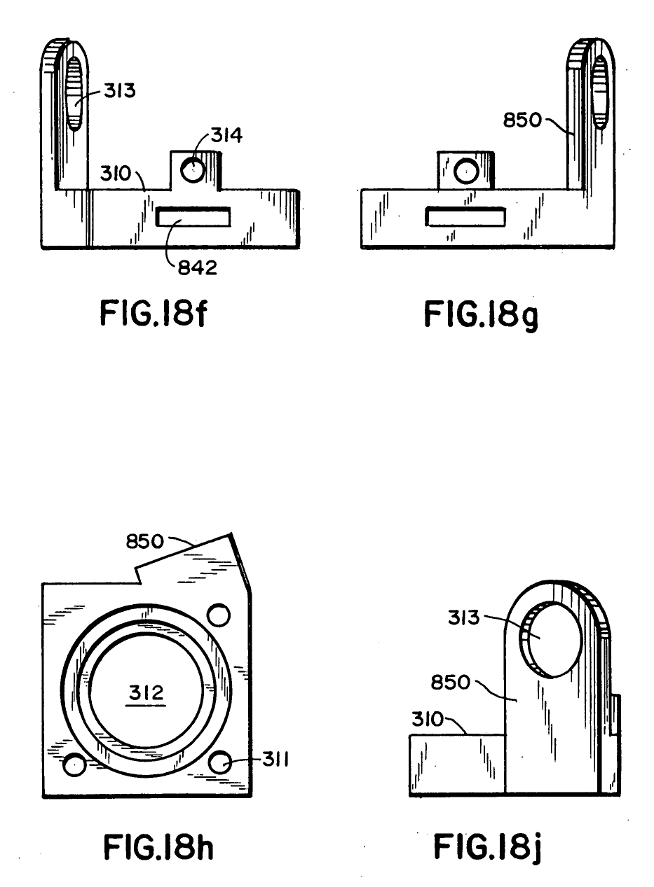

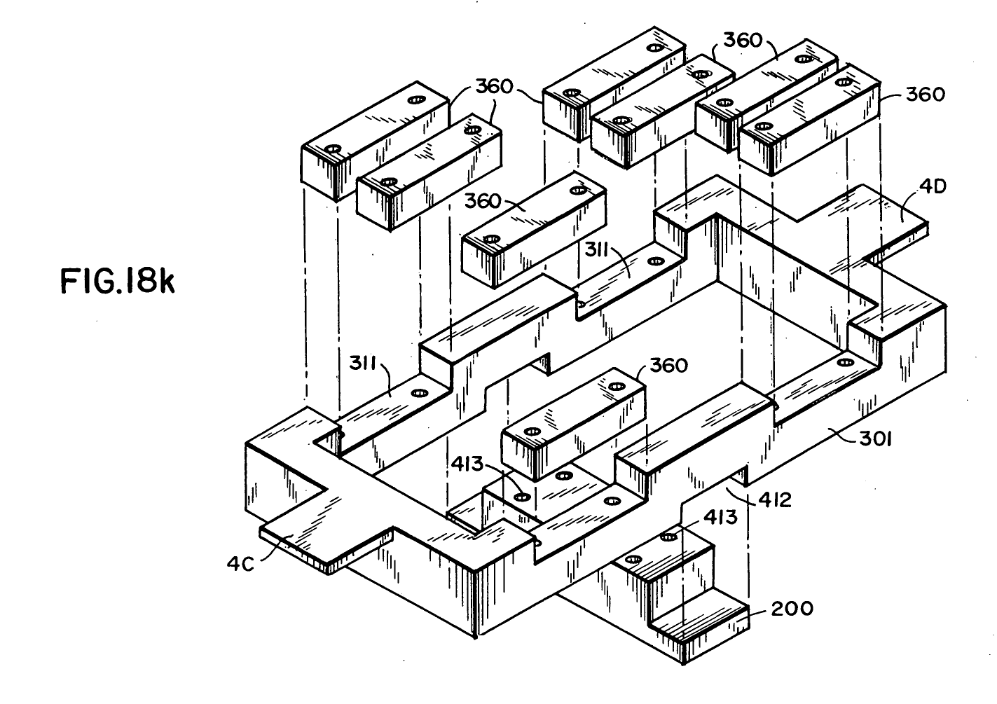

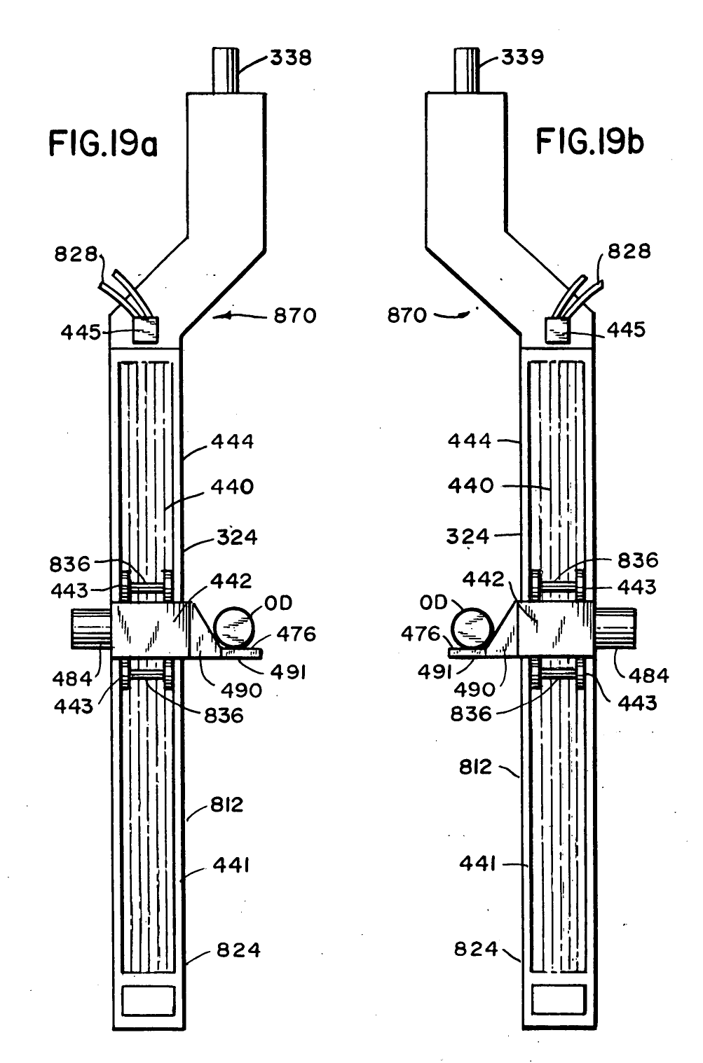

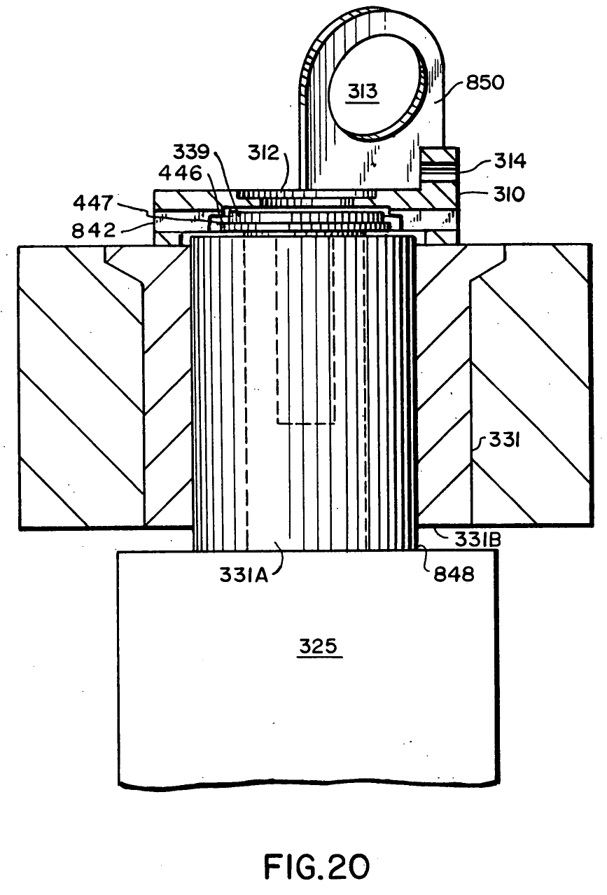

FIGS. 18A-C shows a detailed front (FIG. 18A), right (FIG. 18B), and top (FIG. 18C) view of the horizontal support member 301 and the right angle retainers 310. Crossed roller supported mounts 4A and 4B move laterally in relation to horizontal support member 301. Countersunk bores 307 in each crossed roller supported mounts 4A, 4B are so dimensioned that the flanged thrust bearings 330, 331 are snug fit in the countersunk portion thereof. The orbital track masts 338, 339 are each so dimensioned so as to fit, respectively, through the bores 307 and snug fit through the thrust bearings 330, 331, respectively. Crossed roller sets 360 run atop of the horizontal support member cavities (FIG. 18F) and provide support for the crossed roller supported mounts 4A and 4B. Right angle retainer symmetrical pair 310 is mounted to the crossed roller support mounts 4A and 4B by fasteners (not shown) through holes 311. Bore 312 on right angle retainer 310 allows for access to the top of the orbital tracks drive masts 338, 339 (FIG. 19) and bore 313 allows for panel mounting of the right angle drive and/or flexible control shafts 322, 323, so as to provide a relatively rigid, but flexible power transfer from drive components 332,334 to the orbital track masts 338 and 339. Threaded socket mounts 314 are threaded to mesh with mini linear actuator 326 and 327. The placement and/or the shape of the right angle retainer may be changed, as the components may need to be changed or updated. Right angle retainer distance A is equal to horizontal support member distance A, as seen in FIG. 18B, so that the threaded socket mounts may correctly meet the mini linear actuator.

FIG. 18F shows an exploded perspective view of the horizontal support member 301. Crossed roller sets 360, like those produced by Del-Tron Precision, Inc., 5 Trowbridge Drive Bethel, Conn. 06801, fit into horizontal support member upper cavities 311. Linear thruster housing 200 (previously referred to as manufactured by Ultramation, Inc.) fits into horizontal support member bottom cavities 412. The linear thruster mounted linear nut 201 (FIGS. 18A, 18C) may be permanently mounted to the housing 200. The housing shaft bearings 413 ride the guide shafts 303 in relation to the dorsal mount 318 and helmet 316.

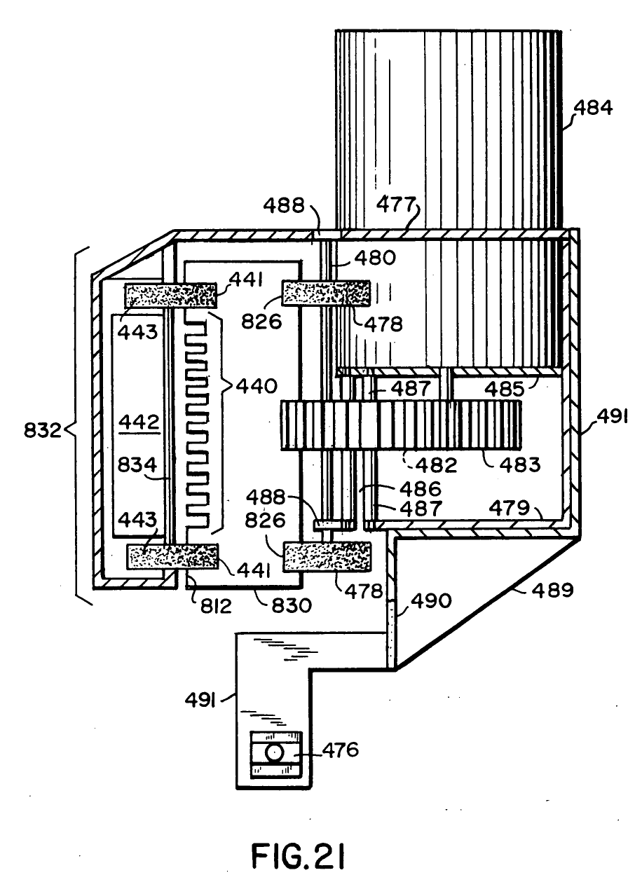

FIG. 19 shows the offset orbital tracks 324, 325, and drive masts 338, 339. The front face 812 of the orbital tracks may be made of a semi-annular slip ring base 440 (as more fully disclosed U.S. Pat. No. 5,054,189, by Bowman, et al., the disclosure of which is incorporated herein by reference) with plated center electro layer grooves 440 and brush block carrier wheel grooves 441. The inner face 824 of the orbital tracks 324, 325 (FIG. 21) has two groove tracks 826 close to the outer edges 830 of the faces 812, 824 and an internal gear groove 481 in the center of the inner face 824. The brush block wheels 443 and the brush block 442 are supported by structural members 832 that are attached to a support member 477 (FIG. 21). The structural member supports the drive component 484 (servo motor 484 with the gear head, brake, encoder, and tach (not visible)). The combination of the foregoing each describe a C-shape about each orbital tracks 324, 325 (FIGS. 19, 20). The orbital track carriage OTC supports a hot shoe connector 476, as seen in U.S. Pat. No. 6,462,894 by Moody, the disclosure of which is incorporated herein by reference, at an angle perpendicular to the tangent of the orbital tracks. Because each vertical rotational axis of each orbital track mast 338, 339 is coincident with the respective vertical axis passing through each eye, the tracks 324, 325 horizontal motion is coincident with the horizontal component of the movement of user's eyes, respectively, even though the tracks 324, 325 are offset from each eye. As the orbital track carriage OTC rides the tracks 324, 325 the optical devices thereon are always substantially at 0° with respect to the optical axis of each of the user's eyes. Each orbital track defines an arc of a circle of predetermined length the center of each will be substantially coincident with the center of each respective eye of the user. A portion of each track 324, 325 while disposed in the same arc, has an offset portion 870 so that the tracks 324, 325 when secured by their respective masts 338, 339 to the horizontal support member 301 will be disposed to either side of the eyes of the user so as to not obstruct the user's vision and permits the mounting of optical devices on the tracks but in line with the user's vision.

The brush block wheels 443 are rotatably connected to each other by a shaft 834. The brush block 442 may be secured the structural members 832, in a manner well known in the art (as by screws, etc.) and so positioned as to allow the brush block brushes 836 (FIG. 19) access to the semi-annular slip ring base 440 while, at the same time, providing a stable, strong, platform to which the drive component is mated. Control and power cables 828 run from the brush block 442 to the drive component 484. At the top and bottom of the tracks 324, 325 are limit switches 444 and above the slip ring 440 on each track may be mounted a cable distribution hub 445.

A groove 446 in the top 838 of each drive mast 338, 339 is dimensioned to accept a retaining ring 447. Each mast 338, 339 may have an axial splined bore 840 which is joined to a mating male splined member (not shown but well known in the art) of the output of the right angle drives 328, 329 (FIGS. 16A-D). Each mast 338, 339 may be so dimensioned as to fit snugly into respective flanged thrust bearing 330, 331. The power and control cable set 828 emanating from the distribution box 445 may have a connector (not shown) that fits a companion connector (not shown) attached to the dorsal mount 318.

Box-like housings, not shown, may each be so dimensioned as that each may enclose and conform generally to the shape of an orbital track 324, 325 which it encloses so as to shield that orbital track 324, 325 from unwanted foreign matter. Each housing is so dimensioned as to provide sufficient clearance so that the orbital track carriage OTC may move unhindered there within. An opening may be provided in each housing so that the support member 491 may extend without the housing. A seal (also not shown) may be disposed in the housing, about the opening and against the support member 491.

FIG. 20 is a partial view of a cross-section of the horizontal support member 301 taken along line 20 in FIG. 18C and looking in the direction of the arrows. This sectional view shows the right orbital track 325 with the mast 339 fit into the thrust bearing 331. The thrust bearing 331 fits into the roller support mount 4B with the mast 339. The right angle retainer 310 is mounted to the top of the roller support mount 4B. The top 850 of the mast 339 is so dimensioned as to extend without the thrust bearing 331 and have therein an annular groove 446 which is so dimensioned to receive a retaining ring 447. Retaining ring 447 thereby engages the mast 339 about the groove 446. In assembly, the retaining ring 447 may be installed by inserting it through slot 842 in the right angle retainer 310 (see, also, FIG. 18D2). The retaining ring 447 secures the mast 339 to the horizontal support member 301 thereby holding the mast 339 in place but permitting the mast 339 to rotate. The orbital track 325 abuts at one end 848 of the internal rotating member 331 A of the flanged thrust bearing 331. Panel mounts (not shown) may be disposed through apertures 313 in the vertical retainer 850 of each right angle mount 310 to receive and hold in place flexible control shafts 322, 323.

The present invention contemplates a fully automated system. However, it is within the scope of this invention to also have adjustment made, instead, by manual positioning. Controls of this type are taught in U.S. Pat. No. 6,462,894 by Moody.

In FIG. 21 a cross sectional view of the orbital track carriage can be seen. A hot shoe connector optical device mount 476 (shown in U.S. Pat. No. 6,462,894 by Moody) is mounted to L-shaped CNC machined rear member 491 which joins the main outer member 477, the stabilizer 479, and interior L-shaped motor faceplate 485. Triangular bracing members 489, 490 is an integral part of rear member 491. Internal gear groove 481 may be machined on the inside of orbital tracks 324, and 325 to mate with spur gears 482 which mate with drive component gear 483 thus forming a rack and pinion. Drive component motors 484, for each orbital track, are each supported by the orbital track carriage support member 477 and L-shaped motor faceplate 485. Spur gear shaft 486 supports spur gear 482. Miniature bearing 488 hold shaft 480 in support member 477 and stabilizer 479. Spacers 487 keep spur gears 482 aligned with drive component gear 483. The hot shoe mount 476 is offset below the center line of the orbital track carriage so as to provide for the correct positioning of the lens (not shown).

In FIG. 22 the orbital tracks 324, 325 are shown as are rubber spacers R1, R2. They are out of the way in their swept back position.

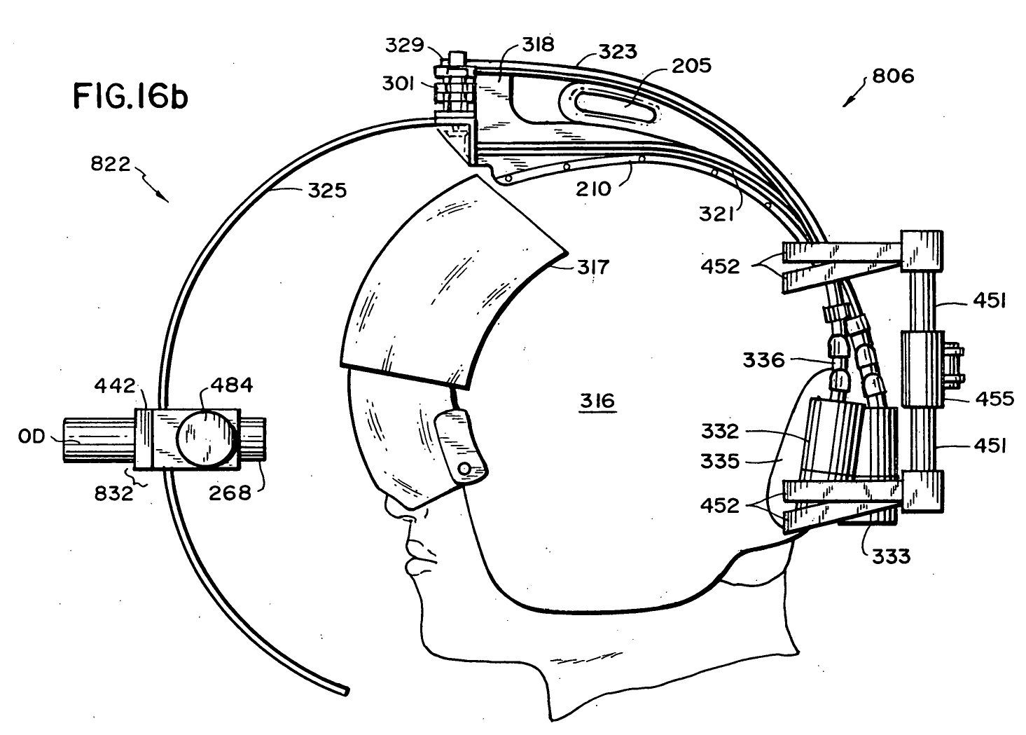

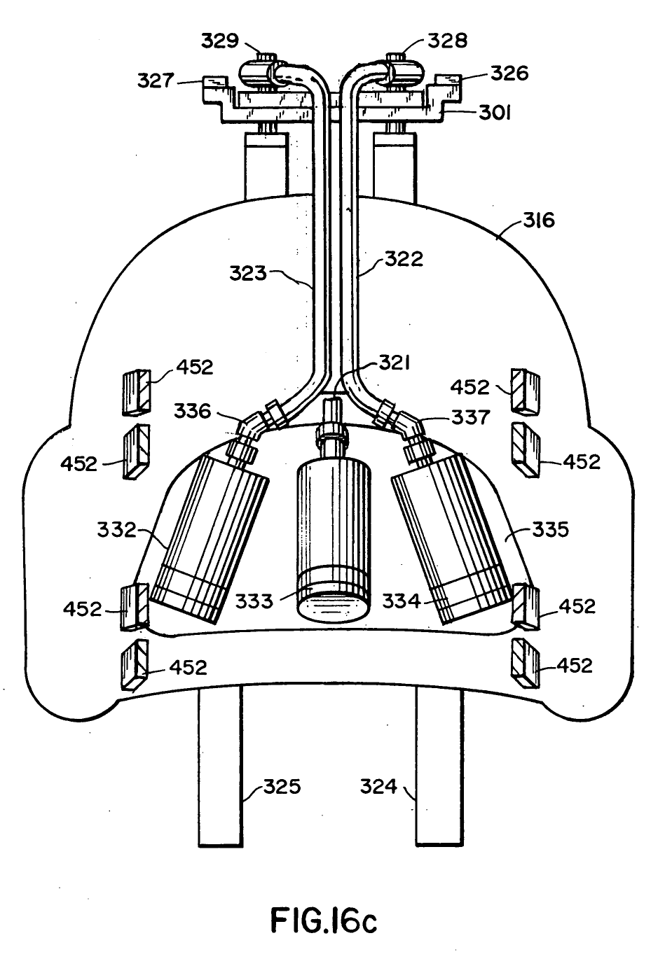

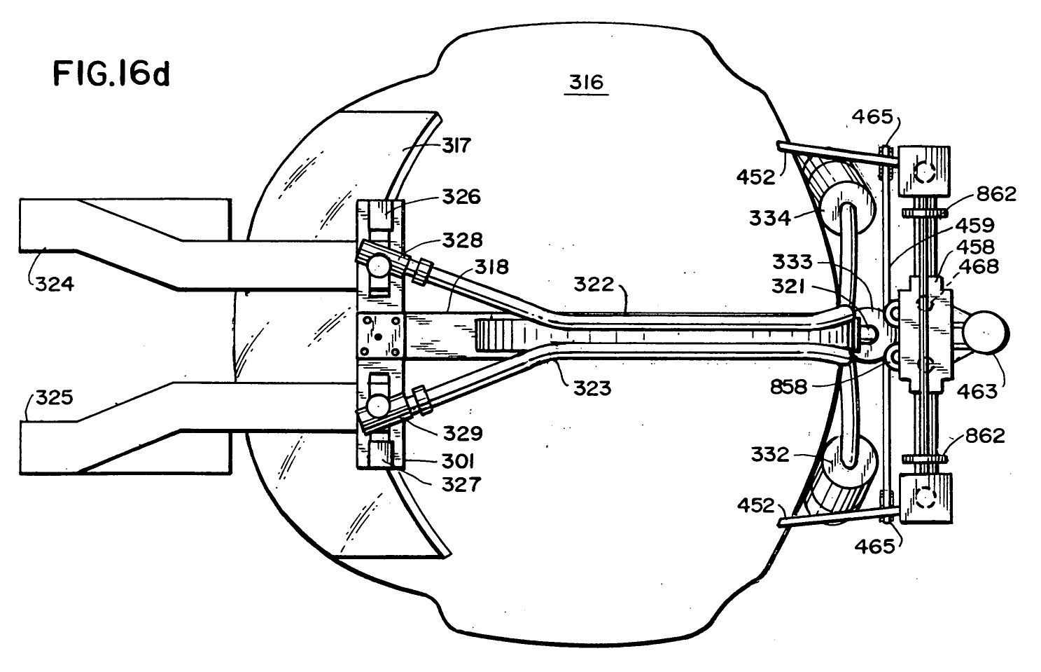

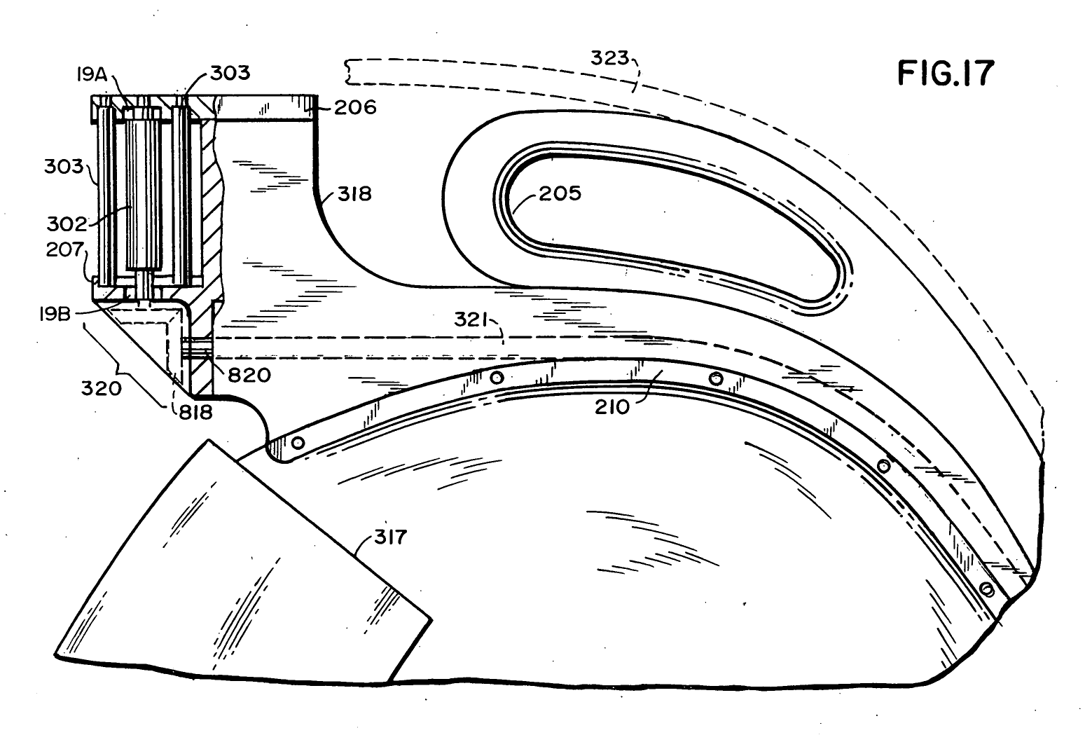

In FIG. 15A, the see-through night vision intensifier tube (as taught by King et al.) and face capturing camera-mounted arrangement are shown. A rear support member 91 may be modified from that shown in FIG. 21 so that a hot shoe-mount 476 may be offset to the rear of the optical track 324, 325 to compensate for the eye relief distance that is usually small. An L-shaped member 91 fits a stabilizer 479 and a support member 477, but the triangular bracing members 89 and 90 are attached to rear part of support member 91R. The see-through night vision devices STNV are mounted to hot-shoe mounts (FIG. 21) and face outward. Wedge members W provide a base positioned at the correct angle to mount the face-capturing cameras 268 via bracket pairs made up of pieces 101, 105 (FIGS. 14E1-E3).

The face capturing cameras 268 (FIG. 15A) may be positioned so as to be able to capture enough of the user's face to pinpoint nodes needed to track the user's eyes in relation to the user's face, rather than the point of regard of the user's eyes. Lines of sight L of the cameras 268, and lines of sight of the see-through night vision devices L2 are not blocked as the configured pairs of devices 852, 854 which rotate about the vertical and horizontal axes of the user's eyes. FIG. 15B shows a detailed view of the left modified support member 91 and attached parts. FIG. 15C is a left side view of the support member 91 taken along line 36 in FIG. 15B and looking in the direction of the arrows.

Because the rotational forces on the helmet 316 by the orbital tracks 324, 325 and orbital track carriages OTC vary as the components move, an active counterweight system must be used. Furthermore, the rotation of the orbital tracks 324, 325 and the orbital track carriage OTC move at speeds commensurate with saccadic movement. The movement of the orbital tracks 324, 325 and the orbital track carriage OTC places a force upon the entire helmet 316 to rotate the helmet 316 in the opposite direction from that movement. To counteract the movement of the helmet 316 there must be an active counterweight system to keep the unit stable.

Vertical guide rods 451 are mounted to helmet 316 via triangular mounts 452 (FIGS. 23A-B). Horizontal guide rods 454 are attached to vertical guide rods 451 via lined linear bearings 455. A motor 456 with a double-ended drive shaft drive shaft 464. A horizontal drive component 463 is mounted to a weight carriage 457 (FIGS. 24A-B) that is comprised of dual lined linear bearings 458. Synchromesh cable pulleys 453 are mounted to the vertical guide rods 451, as is well known, so as not to interfere with the full range of movement of vertical bearings 455. Synchromesh cables 449 engage the synchromesh pulleys 453. The system of guide rods 451, 454 are offset from the rear of the helmet 316 to provide clearance for the rear triangular mount 452 and accompanying drive components 456, 463.

Weight post 460 are mounted to the weight carriage 457, as is well known in the art. (FIG. 23A-B) A cotter pin 462 is disposed through one of a multiplicity of cotter pin holes 461. The cotter pin holes 461 are formed perpendicularly to the major axis of the post 460. The cotter pin 462 may releasably attach weights (not shown) to the weight post 460.

Synchromesh crimp on eyes 465 may be attached to right angle studs 466 that are, in turn, mounted to a bearing sleeve 467 (FIGS. 24A-B). The synchromesh cable 459 runs from the right angle studs 466 to a pair of pulleys 858 and then to a single drive component-mounted pulley 600. Two vertical shafts 468 couple horizontal bearings 458 to one another to thereby provide structural support for the drive component supports 469. The drive component supports 469 hold the drive component 463 in place in relation to the weight carriage 457. Right angle triangularly shaped studs 470 are secured to the vertical bearings 455.

Vertical synchromesh eyes 465 are mounted to the right angle studs 470 with double-ended crimp-on eye fasteners 471. Right angle cross member 472 joins bottom triangular mounts 452. Platform 473 is secured to cross member 472 by well known fastening means to provide a stable platform for the double-ended shaft drive component 456. Vertical pulley shafts 474, 475 support pulleys 858 which are, in turn, rotatably secured to the weight carriage 457. Synchromesh pulleys 862 are rotatably secured to shaft 860. The shaft 860 is sandwiched between bearings 864. The bearings 864 snug fit into recesses 866 in the triangular mounts 452.

The position and movement of the drive components 463, 456 and the structures to which they are attached are controlled by the control system shown in FIG. 12 so as to counteract the rotational forces they impose on the helmet 316. As previously described, the weights are placed on the weight posts 460 to assist in this operation. The weight carriage 457 may move in the same direction as frontal armature 822 in order to counteract the rotational forces. This creates an unbalance, as the armature and weight carriage are both on same side of the center of gravity. This would still be the case without the active counterbalance, but the addition of rotational forces caused by the frontal armature movement creates a less than desirable error in positioning accuracy because the base moves in reaction to the movement of the armature as per Newton's Third Law of Motion. The user may accommodate for this motion. In the alternative, a center of gravity mounted pump (not shown) may be used to move heavy liquid (e.g., mercury) from a reservoir to either side of the helmet to compensate for the imbalance.

In another embodiment of an orbital track system (FIGS. 25A-C), a user (not shown) views images through a remotely placed orbital track mounted optical device pair 868 via a convergence angle display 262 (FIG. 13A-B). Dual slider mounted tracks 503 (FIGS. 25A-C) provide the correct convergence angle as well as the vertical angle of the optical devices (as previously disclosed in FIGS. 19, 21) to provide a reproduction of the human ocular system.

A stand 500 (FIG. 25A) (e.g., a Crank-O-Vator or Cinevator stand produced by Matthews Studio Equipment) has secured to the free end thereof a self-correcting stabilized platform 501. The dual slider mounted tracks 503 are attached as more fully discussed below. The self-correcting stabilized platform 501 is secured to the stand 500 as taught by Grober in U.S. Pat. No. 6,611,662 (the disclosure of which is incorporated herein by reference). A rotary table 502, (like those produced by Kollmorgen Precision Systems Division or others), may be mounted to the self-correcting stabilized platform 501. The rotary table 502 provides a horizontal base for the dual slider mounted tracks 503.

In FIG. 25C, is a modified crossed roller high precision flanged slide 872 (such as the High Precision Crossed Roller Slide (Low Profile) produced by Del-Tron Precision, Inc. 5 Trowbridge Drive, Bethel, Conn. 06801). The slide 872 comprises a carriage 504/505 and base 506. The slide 872 is modified so as to allow for the masts 523 and their integrally formed orbital tracks 522 to have vertical axis rotary motion. The tracks 522 are of substantially same design as the tracks 324, 325 (FIG. 19). The slide 872 is modified by providing an elongated bore 524 in base 506 to receive one end of a vertical carriage mounted tubular flanged thrust bearing/snap-on drive component receptacle 525. To connect the motors 527, 528 to the masts 523 while also having the motors 527, 528 connected to the base 506, so that the tracks 522 can rotate with respect to the base 506, there is provided a substantially planar drive component mount 526 (which is adapted from a flange with a centered vertical tubular keyed “barrel” as taught by Latka in U.S. Pat. No. 5,685,102 the disclosure of which is incorporated herein by reference).

A substantially u-shaped dual track/driver mount 874 (FIG. 25B) comprises the slide 872, the carriages 504 and 505 and the ride slide base 506 attached to the rotary table 507. Legs of the u 508, 509 (disposed at each end of the slide 872) together define the substantially u-shape. The free ends of the support legs 508, 509 may be attached to the rotary table platform 507 as by welding, screws, or similar means. Attached to the slide 872 may be a pair of rack and pinions 510, 511 (attached to sliders 504 and 505, respectively) which are meshed with spur gear 512, as seen in U.S. Pat. No. 6,452,572 by Fan et al., the disclosure of which is incorporated herein by reference.

FIG. 25D shows a close-up cross sectional view of FIG. 25B taken along lines 25D and looking in the direction of the arrows. A snap-on adaptor 525A, as disclosed in Latka, is modified in several ways. The snap-on device disclosed by Latka has one key. Here, there is provided two or more axially extending keys 529 and 530 mounted on a vertical barrel 531 and fit into key recess 532 and 533, complementary in configuration to the key extension disclosed in Latka. The two keys 529, 530 keep the two parts 531, 536 of the snap-on mount 525A from rotating in relation to each other. The threads of Latka for meshing the body 536 and the accessory mount are replaced with a roll pin 540 to keep the various parts 537, 541, 536 from rotating and the accessory mount of Latka is now the flange mount 537 which fits flush into the carriages 504/505. A half dog point or other set screw 538 is screwed into flange mount 537 at socket 539 (within the flange mount) via a threaded shaft 542. The screw 538 may be threaded into only the inside half of the shaft 542 so as to speed up insertion and removal of the screw 538. An annular cam collar 534 is manipulated to release barrel 531 through holes 535 in drive component mount 526.

A spacer 546 is chamfered at the top and meets the bottom of a flanged thrust bearing 543 and the top of the barrel 531. A second non-flanged thrust bearing 544 is disposed inside the barrel 531 to aid in retaining the mast 523. An annular groove 545, in the end of the mast 523, has its upper limit flush with the thrust bearing 544, to allow for the insertion of a retaining clip 546. The retaining clip 546 retains the mast 523 vertically in relation to the carriages 504/505. A slot (not visible) through the barrel 531, the body 536, and the collar 534 may be provided to receive the retaining clip 546. The mast 523 extends through the thrust bearing 544 to accept the drive component shaft 547. The drive component shaft 547 may comprise a male spline (not shown) that meshes with the female spline (not shown) of the mast 523. The crossed roller assemblies 548 and 549 of the Del-Tron cross roller slide allows for horizontal movement of the carriages 504/505 via gear racks 510, 511 and spur gear 512 (FIGS. 25B, 25E). The drive component 527 is fitted with a face mount 550 which is mounted to the snap-on mount 526 by fasteners 551 and spacers 552, so that the tracks 522 can be removed in three steps: first the motor 527, then the mount 526, and then the mast 523.

The base 506 of the cross roller slide (FIG. 25E) may have therein elongated bores 524 and a spacer bar 502 disposed between and perpendicularly thereto. Spur gear 512 axis of rotation is disposed perpendicular to the plane of the base 506, secured to shaft 513 and held in place by base mounted thrust bearings 517. The upper bearing of thrust bearing 517 is disposed in the spacer bar 502 and the lower thrust bearing is disposed in base 506. Base 506 is bored to accommodate the shaft 513 and bearings 517. An L-shaped bracket 518, which is secured to base 506, may have an aperture formed therein and so dimensioned as to accommodate bearing 517, shaft 513, and fasteners 203. A horizontal shaft 515 is mounted have miter gear at one end, and engages a miter gear in the end of vertical shaft 513, forming a miter gear set 514. Thrust bearing socket 204, which is so dimensioned as to retain a thrust bearing 517A, is secured to platform 507 via bores 205 and fasteners (not shown). Knurled knob 516 (FIG. 25B, 25E) allows for the manual manipulation of spur gear 512 via shaft drive system 876. The spur gear 512 engages gear the racks 510 and 511 to change the distance between the centers of rotation of the vertical axes of the orbital tracks 522 (interpupilary distance). In the alternative, the interpupilary distance control mechanism may be motorized.

This set up of an adjustable remote dual orbital tracked optical device pair may be placed on any configuration of a tilt and pan head or any other location. As previously indicated, in all applications, the platform having the camera or weapon can be placed remotely, providing a human ocular system simulator in a place a human cannot or may not wish to go. The platform may be a self leveling, rotating telescopic stand mounted head, allowing the system to be placed at high elevations and increasing the observation capabilities. Different configurations of the tracks may allow for larger lenses for use in long distance 3D photography at the correct optical angle. This system, combined with the Muramoto display, places the viewer at the point in space of the device for use in security, military, entertainment, space exploration, and other applications. Another application is to incorporate the systems herein in combination with the artificial viewing system disclosed by Dobelle in U.S. Pat. No. 6,658,299, the disclosure of which is incorporated by reference.

1-88. (canceled)

89. A tracking system of the type which determines points of regard of the eyes of a user, comprising:
a) means for determining the dynamic orientation of the user's eyes to determine the point of regard of at least one of the user's eyes;
b) at least one device for being trained on a point in space; and
c) means for training said device, in response to said means for determining the dynamic orientation of the user's eye, dynamically orienting said device so as to be trained upon a device first point of regard which is substantially the same physical point in space as said user's first point of regard.

90. A tracking system as recited in claim 89 wherein said means for determining the dynamic orientation of the user's eyes further comprises means for determining the dynamic orientation of the user's eyes with respect to said first and then a second point of regard of the user's eyes; said means for positioning said device, in response to said means for determining the dynamic orientation of the user's eyes, being capable of dynamically orienting said means for training of said device so as to dynamically orient said device from said first point of regard of said device to a second point of regard of said device which said second point of regard of said device is substantially the same point in space as said second point of regard of the user's eyes.

91. A tracking system as recited in claim 90 wherein said device is capable of being selectively continuously trained upon said points of regard of the user's eyes.

92. A tracking system as recited in claim 91 wherein said means for determining the dynamic orientation of the user's eyes comprises an eye tracker.

93. A tracking system as recited in claim 92 wherein said means for determining the dynamic orientation of the user's eyes further comprises means for tracking the dynamic orientation of the user's head.

94. A tracking system as recited in claim 93 where in said means for tracking the dynamic orientation of the user's head comprises a head tracker.

95. A tracking system as recited in claim 94 further comprises means for processing and wherein said processing means comprises means for calculating said points of regard of the user's eyes.

96. A tracking system as recited in claim 95 wherein said processing means further comprises a controller, said controller providing means for directing said means for training said device so as to cause said means for training said device to change the dynamic orientation of said device from being trained upon said first point of regard of said device to being trained upon said second point of regard of said device.

97. A tracking system as recited in claim 96 wherein said processing means calculates said point of regard of the user's eyes and said point of regard of said device, compares said points of regard and thereby provides instructions to said means for positioning said device to dynamically orient said device from said first to said second point of regard of said device.

98. A tracking system as recited in claim 97 wherein said eye tracker comprises means for measuring and sensing voltages of the muscles surrounding the orbits of the user's eyes to thereby determine the dynamic orientation of the user's eyes.

99. A tracking system as recited in claim 98 further comprises a plurality of localizer means for providing localizer signals; a headset for being worn by the user; at least some of the localizer means being secured to said headset; said localizer signals being indicative of the relative location of said headset and said training device means with respect to one another.

100. A tracking system as recited in claim 99 wherein said localizer means comprises a multiplicity of headset localizers coupled to said headset at predetermined locations; a multiplicity of device localizers coupled to said means for training at predetermined locations; and a multiplicity of stationary localizers.

101. A tracking system as recited in claim 100 wherein said measuring and sensing means and said localizer means providing signals to said processor means so that said processor means thereby calculates from said localizer signals the dynamic orientation of the user's eyes.

102. A tracking system as recited in claim 101 wherein said localizer signals are coupled to said processing means so that said processor means thereby calculates from said localizer signals the dynamic orientation of said device.

103. The tracking system as recited in claim 102 wherein said device is a camera.

104. The tracking system as recited in claim 103 wherein said device is a weapon.

105. The tracking system as recited in claim 102, further comprises first display means for displaying a predetermined area which includes said point of regard of said device.

106. The tracking system as recited in claim 105, further comprises means for providing a video signal of said predetermined area; said video signal providing means coupled to said device.

107. The tracking system as recited in claim 106 further comprises means for processing said video signals and for marking a physical object within said predetermined area.

108. The tracking system as recited in claim 107 further comprises automatic tracking means for causing said means for training said device to be capable of following said physical object.

109. The tracking system as recited in claim 108 further comprises said eye tracker providing signals indicative of said points of regard of said eyes of the user.

110. The tracking system as recited in claim 109 further comprises person tracker auto tracker switch means for selectively switching said signals from either said signals from said head tracker localizers, said stationary localizers, and said eye tracker or signals from said automatic tracking means to said processor such that with said person tracker auto tracker switch means in a first position signals from said head tracker localizers, stationary localizers and said eye tracker are processed by said processor so as to provide signals to said controller for coordinating said points of regard of said device to be substantially coincident with said points of regard of the eyes of the user and, in a second position, signals from said automatic tracking means are provided to said processor so as to provide signals to said controller for providing signals to thereby train said device upon said object.

111. The tracking system as recited in claim 110, further comprises blink switch means for coupling predetermined signals from said eye tracker to said person tracker auto tracker switch.

112. The tracking system as recited in claim 111 wherein said predetermined signals from eye tracker comprises blink signals; said eye tracker means comprises means for determining the length of time the user eyes are shut and the user's eyes reacquires said user's point of regard and providing said blink signal indicative of said length of time; said blink signal controlling said person tracker auto tracker switch means so as to cause said person tracker auto tracker switch means to switch to said first position to said second position during said period of time.

113. The tracking system as recited in claim 112 wherein said person tracker auto tracker switch means further comprises means for manually switching from said first position to said second position.

114. The tracking system as recited in claim 113 further comprises image processing means; said device comprises a film camera having a video output port for providing a video output signal indicative of the image being received by the film in said film camera; said video output signal being coupled to said image processing means; said image processing means processing said video output signal to provide a noninterrupted signal to said automatic tracking means.

115. The tracking system as recited in claim 92 further comprises second display means and said device comprises a camera; said camera comprising means for providing video signals indicative of the image received by the lens of the camera.

116. The tracking system as recited in claim 115 wherein said second display means is coupled to the user's head.

117. The tracking system as recited in claim 116 further comprises a headset worn by the user and wherein said second display comprises a flip down display secured said headset.

118. The tracking system as recited in claim 117 further comprises a headset worn by the user and wherein said second display comprises a heads up display secured to said headset.

119. The tracking system as recited in claim 101 further comprises second display means and said device comprises a camera; said camera comprising means for providing video display signals to said second display indicative of the image received by the lens of the camera.

120. The tracking system as recited in claim 119 wherein said second display means is coupled to the user's head.

121. The tracking system as recited in claim 120 further comprises an up-down switch means for, in a first position, coupling said localizer signals from said localizers secured to said head set to said processor and, in a second position, blocking said localizer signals from said localizers secured to said head set to said processor; said localizer signals from said head set being blocked when said second display receives said video signals from said camera.

122. The tracking system as recited in claim 121 wherein said up-down switch means comprises a manual toggle switch.

123. The tracking system as recited in claim 122 wherein said device further comprises a weapon and wherein said camera is coupled to said weapon and said camera is focusable upon said point of regard of said weapon.

124. A system for determining and positioning a device with respect to at least one predetermined location on a face, comprising:
a) optical device means for providing indicia indicative of the location; and
b) means, responsive to said indicia, for positioning said optical device means with respect to the location.

125. The system of claim 124 wherein said positioning means comprises means for tracking the face to thereby calculate and provide position indicia representative of the location.

126. The system of claim 125 wherein said tracking means comprises face tracking means.

127. The system of claim 126 wherein said optical device means comprises camera means for receiving an image of at least the location and converting said image into indicia representative thereof.

128. The system of claim 127 wherein said means for tracking receiving said indicia and calculating there from the location.

129. The system of claim 128 wherein said positioning means comprises means for dynamically determining the location of at least one eye on the face.

130. The system of claim 129 wherein said means for dynamically determining the location comprises an eye tracker.

131. The system of claim 130 wherein said positioning means further comprises

132. A mechanism for positioning a device with respect to a ventrum of a user comprising:
a) track means for supporting the device; and
b) means operatively coupled to the device for selectively moving the device to predetermined locations with respect to the ventrum.

133. The mechanism of claim 132 wherein said means for moving the device further comprises means for moving the device within the field of view of the user.

134. The mechanism of claim 133 wherein the device comprises means for at least taking an image of the user's face.

135. The mechanism of claim 134 wherein the device further comprises means for taking an image of the field of view of the user.

136. The mechanism of claim 135 where in said means for taking an image of the field of view of the user comprises means for determining said field by sound waves.

137. The mechanism of claim 136 where in said means for determining said field by sound waves comprises a microphone.

138. The mechanism of claim 136 wherein said means for taking an image of the field of view of the user comprises optical sensing means.

139. The mechanism of claim 133 wherein said track means comprises a rack and pinion and said rack is disposed in an arc facing the user's eyes and with the user's eyes substantially at the center of said arc.

140. The mechanism of claim 139 further comprising carriage means; said device being secured to said carriage means; the teeth of said rack being disposed facing the ventrum of the user and wherein the opposed side of said rack having grooves therein; carriage means movably secured to said rack and having wheels for engaging said grooves so as to be movable along said rack; and means for transmitting electrical signals.

141. The mechanism of claim 140 wherein said optical device means comprises optical devices and motor means secured to said carriage; said motor means for propelling the pinion so as to position said optical devices along said rack to predetermined locations; said optical devices comprises a first optical device for receiving the image of the user and a second optical device for receiving the image of the field of view of the user.

142. The mechanism of claim 141 further comprises means for transmitting electrical signals to and from said motor means and said optical devices.

143. The mechanism of claim 142 wherein said track means comprises a track and further comprises means for transmitting electrical signals includes at least one side of said track being electrically conductive and in the shape of at least a part of a slip ring for transmitting said signals.

144. The mechanism of claim 143 wherein said track means further comprises means for moving the device laterally with respect to the ventrum.

145. The mechanism of claim 144 wherein said track means comprises helmet means and said track comprises at least one rigid track pivotally secured to said helmet means such that said track is movable in an arc with reference to the ventrum.

146. The mechanism of claim 145 wherein said helmet means comprises a helmet; means for pivotally securing said track to said helmet with a pivot point of said track alignable with an eye of the user and said track being offset from said pivot point so that said track is positionable out of alignment with the visual axis of the eye of the user.

147. The mechanism of claim 146 further comprises a heads up display pivotally secured to said helmet.

148. The mechanism of claim 147 wherein said optical devices are secured to said track so that the center of focus of said optical devices are in a coincident line and are positionable to alignment with the visual axis of the eye.

149. The mechanism of claim 148 wherein said means for pivotally securing said track to said helmet comprises mount means for selectively positioning said track with reference to said helmet by raising or lowering said track with reference to the exposed surface of said helmet and from side-to-side with reference to the eye of the user.

150. The mechanism of claim 149 wherein said means operatively coupled to the device for selectively moving the device comprises means for selectively moving said track and further comprises eye tracking means coupled to at least one eye of the user for sensing the point of regard of the user's eye and providing signals indicative thereof; processing means for receiving and processing said signals indicative of said point of regard to thereby produce control signals; drive means coupled to said processing means to receive said control signals and respond thereto to thereby move said rack to predetermined positions.

151. The mechanism of claim 150 wherein there are two tracks, each pivotally secured to said helmet; said tracks being ganged together for being jointly raised or lowered with reference to said helmet and wherein said tracks being movable from side-to-side substantially independent of one another.

152. The mechanism of claim 151 wherein said tracks being so pivotally secured to said helmet such that each of said pivotal movement of each of said tracks and of each of said optical devices is independent of said other track and each in one of said optical devices thereon.

153. The mechanism of claim 133 wherein said means for moving the device further comprises means for moving the device vertically with respect to the ventrum.

154. The mechanism of claim 143 wherein said motor means further comprises means for moving said optical devices vertically with respect to the ventrum.

155. The mechanism of claim 154 wherein said means operatively coupled to the device for selectively moving the device comprises means for selectively moving said optical devices and further comprises eye tracking means coupled to at least one eye of the user for sensing the point of regard of the user's eye and providing signals indicative thereof; processing means for receiving and processing said signals indicative of said point of regard to thereby produce control signals; drive means coupled to said processing means to receive said control signals to thereby move said optical devices along said track to predetermined positions.

156. The mechanism of claim 155 wherein there are two of said tracks, each pivotally secured to said helmet, one for each eye of the user and wherein said motor means on each of said tracks moves said optical devices on one track independently of said motor means and optical devices on said other track.

157. A system for selectively positioning at least one optical device with respect to at least one eye of a user comprising:
a) at least one arc-shaped track;
b) at least one carriage movably secured to said track and having the optical device secured thereto;
c) means for moving said carriage; and
c) means for rotating said track.

158. A system as recited in claim 157 wherein the center of said arc of said track is substantially the same as the center of rotation of the eye of the user.

159. The system as recited in claim 158 further comprises support means; said track being movably secured to said support means so that said track is pivotally rotatable about an axis which is substantially parallel to the vertical axis of the head of the user.

160. The system as recited in claim 159 wherein said track being offset from said pivot point so that the optical device is in substantial alignment with the axis of rotation passing through said pivot point.

161. The system as recited in claim 160 further comprises a self-leveling head to keep said track level.

162. The system as recited in claim 161 further comprises a rotatable table secured to the upper surface of said self-leveling head and a housing secured to the upper surface of said table; said track being pivotally rotatable secured to said housing.

163. The system as recited in claim 162 further comprises an eye tracker removable secured to the user; a display screen disposed in front of the eye of the user; said optical device obtaining an image; means for displaying said image upon said screen to be viewed by the user's eye; means for moving said optical device and said track in response to the point of regard of the user's eye.

164. The system as recited in claim 160 and wherein said carriage means comprises a carriage; said track and said carriage comprising a rack and pinion with said rack defining at least a part of the concave portion of said track; said pinion engaging said rack and the optical device being disposed on the side of said track opposed to said rack.

165. The system as recited in claim 164 said carriage means further comprises at least one motor for turning said pinion for selectively positioning said carriage along said track.

166. The system as recited in claim 165 further comprises two arc tracks each with one of said carriages movably secured thereto; wherein said pivot points of said tracks are spaced from one another by substantially the interpupilary distance of the eyes of the user.

167. The system as recited in claim 166 further comprises means for adjusting said distance between said pivot points so as to conform to the interpupilary distance of the user.

168. The system as recited in claim 167 further comprises a self-leveling head to keep said tracks level.

169. The system as recited in claim 168 further comprises a rotatable table secured to the upper surface of said self-leveling head and a housing secured to the upper surface of said table; said tracks being pivotally rotatable secured to said housing.

170. The system as recited in claim 169 further comprises an eye tracker removable secured to the user; a display screen disposed in front of the eyes of the user; each of said optical devices obtaining an image; means for displaying each of said images upon said screen to be viewed by the respective user's eyes; means for moving said optical devices and said tracks in response to the point of regard of the user's eyes.

171. The mechanism of claim 150 further comprising counterweight means secured to the dorsal of said helmet for counteracting rotational forces upon said helmet by any moment created by movement of said tracks.

172. The mechanism of claim 171 wherein said counterweight means comprises a counterweight; said processing means calculates the rotational forces enacted upon said helmet by the movement of said tracks and carriages and head mounted display and provides signals to said counterweight means; said counterweight means, in response to said signals moves said counterweight so as to counterbalance said rotational forces.

173. The mechanism of claim 172 wherein said counterweight comprises a pair of opposed vertical guide rods; slide members slidably mounted to said guide rods; a pair of horizontal guide rods secured to said slide members; a weight slidably attached to said horizontal slide members such that said weight moves upon said with respect to said helmet so as to counter balance the rotational moment of said helmet.

174. The mechanism of claim 173 wherein said counterweight means further comprises:
a) a mount secured to and extending from the top to the dorsal of said helmet;
b) mechanical control means secured to said mount; said tracks being secured to said control means; said control means being capable of rotating said tracks, and raising and lowering said tracks at least parallel to the vertical axis of the head of the user and means for adjusting the distance between said tracks to substantially replicate the interpupilary distance of the user's eyes;
c) flexible control shafts extending from said mechanical control means to the dorsal of said helmet; said control shafts operatively connected to said control means for causing said raising, lowering, and rotating; and
d) motor means secured to said dorsal portion of said helmet and connected to and selectively turning said control shafts.

175. The tracking system as recited in claim 97 wherein said means for positioning said device provides indicia which indicates the orientation thereof.

176. The tracking device as recited in claim 175 wherein said means for positioning said device is a camera or weapon positioning device.

177. The method of controlling the orientation of a device in response the point of regard of the eyes of a user comprising:
a) determining the dynamic orientation of the user's eyes;
b) using the dynamic orientation of the user's eyes to determine at least a first point of regard of the eyes; and
c) training the device upon a first point of regard of the device which device point of regard is substantially the same point in space as the user's first point of regard.

178. The method as recited in claim 177 wherein:
the step of determining the dynamic orientation of the user's eyes comprises determining the dynamic orientation of the user's eyes with respect to the first and then a second point of regard;
orienting, dynamically, the device from the first point of regard of the device to a second point of regard of the device and in which the first and then the second points of regard of the device are substantially the same points in space as a first and then the second points of regard of the user's eyes, respectively.

179. The method as recited in claim 178 wherein the step of training comprises training the device selectively and continuously from the first to the second points of regard of the device.

180. The method as recited in claim 179 wherein the step of determining the dynamic orientation of the user's eyes includes determining the orientation of the eyes with respect to the user's head.

181. The method as recited in claim 180 wherein the step of determining the dynamic orientation of the user's eyes further comprises determining the dynamic orientation of the user's head with respect to a predetermined location in space.

182. The method as recited in claim 181 wherein the step of determining the dynamic orientation of the user's eyes further comprises calculating the first and the second points of regard of the user's eyes.

183. The method as recited in claim 182 wherein the step of training further comprises: comparing the calculations of the first and then the second points of regard of the user's eyes;
calculating the first point of regard of the device;
orienting dynamically the device from the first to the second point of regard of the device in response to the results of the step of comparing the calculations of the first and then the second points of regard of the user's eyes and the step of calculating the first point of regard of the device.

184. The method as recited in claim 183 wherein the step of orienting dynamically the device comprises determining the dynamic orientation of the device with respect to at least one predetermined location in space.

185. The method as recited in claim 184 wherein the step of determining the dynamic orientation of the eyes further comprises sensing and measuring the voltages of the muscles which surround the orbits of the user's eyes so as to track the position of the user's eyes.

186. The method of claim 185 further comprises:
providing location indicating apparatus;
indicating, with the indicating apparatus, locations;
coupling indicating apparatus to the user's head and the fixed location in space; and
using the relative locations of the indicating apparatus with respect to each other in the calculation of the points of regard of the user's eyes.

187. The method of claim 186 further comprises coupling indicating apparatus to the device.

188. The method of claim 187 further comprises fixing the indicating apparatus to predetermined locations with respect to the head of the user, predetermined locations with respect to the device, and predetermined locations at the fixed location in space.

189. The method of claim 188 further comprises using the predetermined locations in dynamically orienting the device.

190. The method of claim 189 further comprises selecting a virtual field in which is located at least an object which is substantially located at the first point of regard of the user's eyes; acquiring the object within the field; and dynamically positioning the device so that the point of regard of the device is substantially coincident with respect to the object.

191. The method of claim 190 further comprises orienting dynamically the device so that the point of regard of the device is substantially coincident with the object when the user's point of regard is not coincident with the object.

192. The method of claim 191 further comprises changing the size of the field; using the size of the field in controlling the point of regard of the device with respect to the object.

193. The method of claim 192 further comprises determining that the user's point of regard is unavailable for a predetermined period of time as a precondition for the steps of acquiring the object and dynamically orienting the device so that the point of regard of the device is substantially coincident with the object.

194. The method of claim 190 further comprises choosing to dynamically orient the device as either a function of the point of regard of the user's eyes or as a function of the location of the object.

195. The method of claim 193 further comprises orienting dynamically the point of regard of the device to be substantially the same as the location of the object as the position of the device and the location of the object change with respect to one another.

196. The method of claim 194 further comprises orienting dynamically the point of regard of the device to be substantially the same as the location of the object as the position of the device and the location of the object change with respect to one another.

197. The method of claim 179 further comprises selecting a virtual field including therein a point of regard of the device.

198. The method of controlling the orientation of a device in response the point of regard of the eyes of a user comprising:
a) displaying visually to the user's eyes a field which includes a first point of regard of the device; and
b) determining the dynamic orientation of the user's eyes so that a point of regard of the user's eyes is substantially within the displayed field.

199. The method as recited in claim 198 further comprising:
dynamically orienting the device from the first point of regard of the device to a second point of regard of the device which second point of regard is substantially coincident with the point of regard of the user's eyes.

200. The method of claim 199 wherein before the step of displaying visually the field, the steps of:
a) determining the dynamic orientation of the user's eyes;
b) using the dynamic orientation of the user's eyes to determine at least a first point of regard of the eyes; and
c) training the device upon the first point of regard of the device which device point of regard is substantially the same point in space as the user's first point of regard.

201. The method as recited in claim 200 wherein in the step of dynamically orienting the device from the first point of regard of the device to the second point of regard of the device, the point of regard of the user's eyes is a second point of regard of the user's eyes.

202. The method as recited in claim 201 further comprising controlling the device so as change the visual display of the field.

203. The method as recited in claim 202 further comprising providing a camera; zooming the field by means of the camera.

204. The method as recited in claim 203 further comprises providing a visual display coupled to the head of the user.

205. The method of claim 185 further comprises determining the dynamic orientation of the device with respect to a first point of regard of the device with respect to the first point in space and then calculating the dynamic orientation of the device with respect to a second point of regard of the device with respect to the second point in space; the step of training the device includes orienting the device dynamically so that the point of regard of the device is changed in response to the calculations, thereby dynamically orienting the point of regard of the device to be substantially the same point in space corresponding to the second point of regard of the user's eyes.

206. A method of aligning an optical device with the eye of a user comprising
a) illuminating the eye of the face of the user with light;
b) capturing an image of the face using the light reflected from the face of the user;
c) determining points on the user's face; and
d) positioning the optical device with respect to predetermined points on the user's face.

207. The method recited in claim 206 wherein the step of determining points on the user's face comprises processing the captured image to determine the points.

208. The method recited in claim 207 further comprises providing a stored model of a human face and wherein the step of determining the points on the user's face further comprises deriving from the captured image indicia indicative of points on the user's face and comparing the indicia with the stored model.

209. The method recited in claim 208 further comprises using the determined location of the user's eyes so as to move the optical device into alignment with the user's eyes.

210. The method of positioning a device with respect to a ventrum of a user comprising:
a) supporting the device with respect to the user's ventrum; and
b) moving the device selectively to predetermined locations with respect to the ventrum.

211. The method as recited in claim 210 wherein said step of moving the device further comprises moving the device within the field of view of the user.

212. The method as recited in claim 211 wherein the step of moving the device comprises moving the device in at least one arc with the user's eye substantially at the center of the arc and the rotation of the device is about a point on the horizontal axis of the eye.

213. The method as recited in claim 212 wherein the step of moving the device in an at least one arc comprises moving the device in a second arc with the center of rotation of the second arc coincident with a point on the vertical axis of the eye of the user.

214. The method as recited in claim 213 wherein the step of moving the device in the two arcs comprises providing two devices, one for each eye.

215. The method as recited in claim 213 further comprises taking an image of the user's face.

216. The method as recited in claim 215 wherein the step of taking an image of the user's face device further comprises taking an image of the field of view of the user.

217. The method as recited in claim 216 wherein the step of taking an image of the field of view of the user comprises determining the field by sound waves.

218. The method as recited in claim 215 wherein the step of taking an image of the field of view of the user comprises determining the filed of view with an optical sensor.

219. The method as recited in claim 214 further comprises moving each of devices independently of one another.

220. The method as recited in claim 218 further comprises locating the optical device with its optical axis alignable with the optical axis of the eye.

221. The method as recited in claim 215 further comprises providing a display for displaying an image; mounting the display so as to be viewed by the user; displaying an image of the field of view of the user on the display.

222. The method as recited in claim 210 further comprises providing a display for displaying an image; mounting the display so as to be viewed by the user; displaying an image of the field of view of the user on the display.

223. The method as recited in claim 222 wherein in the step of provide the display, mounting the display so that it can be pivotally moved into and out of the field of view of the user.

224. The method as recited in claim 213 further comprises:
a) determining the dynamic orientation of the user's eyes;
b) using the dynamic orientation of the user's eyes to determine at least a first point of regard of the eyes; and
c) training at least the one device upon a first point of regard of the device which device point of regard is substantially the same point in space as the user's first point of regard.

225. The method as recited in claim 224 wherein:
the step of determining the dynamic orientation of the user's eyes comprises determining the dynamic orientation of the user's eyes with respect to the first and then a second point of regard;
orienting, dynamically, the device from the first point of regard of the device to a second point of regard of the device and in which the first and then the second points of regard of the device are substantially the same points in space as a first and then the second points of regard of the user's eyes, respectively.

226. The method as recited in claim 225 wherein the step of training comprises training the device selectively and continuously from the first to the second points of regard of the device.

227. The method as recited in claim 226 wherein the step of determining the dynamic orientation of the user's eyes includes determining the orientation of the eyes with respect to the user's head.

228. The method as recited in claim 227 wherein the step of determining the dynamic orientation of the user's eyes further comprises determining the dynamic orientation of the user's head with respect to a predetermined location in space.

229. The method as recited in claim 228 wherein the step of determining the dynamic orientation of the user's eyes further comprises calculating the first and the second points of regard of the user's eyes.

230. The method as recited in claim 229 wherein the step of training further comprises: comparing the calculations of the first and then the second points of regard of the user's eyes;
calculating the first point of regard of the device;
orienting dynamically the device from the first to the second point of regard of the device in response to the results of the step of comparing the calculations of the first and then the second points of regard of the user's eyes and the step of calculating the first point of regard of the device.

231. The method as recited in claim 230 wherein the step of determining the dynamic orientation of the eyes further comprises sensing and measuring the voltages of the muscles which surround the orbits of the user's eyes so as to track the position of the user's eyes.

232. The method as recited in claim 230 wherein the step of orienting dynamically the device comprises determining the dynamic orientation of the device with respect to at least one predetermined location in space.

233. The method of claim 232 further comprises:
providing location indicating apparatus;
indicating, with the indicating apparatus, locations;
coupling indicating apparatus to the user's head and the fixed location in space; and
using the relative locations of the indicating apparatus with respect to each other in the calculation of the points of regard of the user's eyes.

234. The method of claim 233 further comprises coupling indicating apparatus to the device.

235. The method of claim 234 further comprises fixing the indicating apparatus to predetermined locations with respect to the head of the user, predetermined locations with respect to the device, and predetermined locations at the fixed location in space.

236. The method of claim 235 further comprises using the predetermined locations in dynamically orienting the device.

237. The method of claim 236 further comprises selecting a virtual field in which is located at least an object which is substantially located at the first point of regard of the user's eyes; acquiring the object within the field; and dynamically positioning the device so that the point of regard of the device is substantially coincident with respect to the object.

238. The method of claim 237 further comprises orienting dynamically the device so that the point of regard of the device is substantially coincident with the object when the user's point of regard is not coincident with the object.

239. The method of claim 238 further comprises changing the size of the field; using the size of the field in controlling the point of regard of the device with respect to the object.

240. The method of claim 239 further comprises determining that the user's point of regard is unavailable for a predetermined period of time as a precondition for the steps of acquiring the object and dynamically orienting the device so that the point of regard of the device is substantially coincident with the object.

241. The method of claim 240 further comprises choosing to dynamically orient the device as either a function of the point of regard of the user's eyes or as a function of the location of the object.

242. The method of claim 241 further comprises orienting dynamically the point of regard of the device to be substantially the same as the location of the object as the position of the device and the location of the object change with respect to one another.

243. The method of claim 242 further comprises orienting dynamically the point of regard of the device to be substantially the same as the location of the object as the position of the device and the location of the object change with respect to one another.

244. The method of claim 226 further comprises selecting a virtual field including therein a point of regard of the device.

245. The method as recited in claim 210 wherein the step of moving the device comprises moving the device in at least one arc and rotating the device about a horizontal axis passing through the center of rotation of the arc.

246. The method as recited in claim 245 wherein the step of moving the device in an at least one arc comprises moving the device in a second arc having substantially the center of rotation as the first arc and about a vertical axis substantially passing through the center of rotation.

247. The method as recited in claim 246 wherein the step of moving the device in the two arcs comprises providing two devices; moving each of devices independently of one another.

248. The method as recited in claim 247 further comprises spacing each horizontal axis from one another at substantially the same distance as between the optical axes of the user's eyes and spacing the vertical axes form one another substantially as the interpupilary distance of the eyes of the user.

249. The method as recited in claim 248 wherein the step of providing devices further comprises providing optical devices each capable of receiving and transmitting an image of a field of view of each device; providing means for displaying each image; mounting the displaying means so as to be viewed by the user.

250. The method as recited in claim 249 wherein in the step of provide the means for displaying images, mounting the means for displaying images so that the displaying means can be pivotally moved into and out of the field of view of the user.

251. The method as recited in claim 250 further comprises:
a) determining the dynamic orientation of the user's eyes;
b) using the dynamic orientation of the user's eyes to determine at least a first point of regard of the eyes; and
c) training at least the one of the optical devices upon a first point of regard of the devices which devices point of regard is substantially the same point in space as the user's first point of regard.

252. The method as recited in claim 251 wherein:
the step of determining the dynamic orientation of the user's eyes comprises determining the dynamic orientation of the user's eyes with respect to the first and then a second point of regard;
orienting, dynamically, the devices from the first point of regard to a second point of regard of the devices and in which the first and then the second points of regard of the devices are substantially the same points in space as a first and then the second points of regard of the user's eyes, respectively.

253. The method as recited in claim 252 wherein the step of training comprises training the devices selectively and continuously from the first to the second points of regard of the devices.

254. The method as recited in claim 253 wherein the step of determining the dynamic orientation of the user's eyes includes determining the orientation of the eyes with respect to the user's head.

255. The method as recited in claim 254 wherein the step of determining the dynamic orientation of the user's eyes further comprises determining the dynamic orientation of the user's head with respect to a predetermined location in space.

256. The method as recited in claim 255 wherein the step of determining the dynamic orientation of the user's eyes further comprises calculating the first and the second points of regard of the user's eyes.

257. The method as recited in claim 256 wherein the step of training further comprises: comparing the calculations of the first and then the second points of regard of the user's eyes;
calculating the first point of regard of the devices;
orienting dynamically the devices from the first to the second point of regard of the devices in response to the results of the step of comparing the calculations of the first and then the second points of regard of the user's eyes and the step of calculating the first point of regard of the devices.

258. The method as recited in claim 257 wherein the step of determining the dynamic orientation of the eyes further comprises sensing and measuring the voltages of the muscles which surround the orbits of the user's eyes so as to track the position of the user's eyes.

259. The method as recited in claim 258 wherein the step of orienting dynamically the device comprises determining the dynamic orientation of the device with respect to at least one predetermined location in space.

260. A tracking system, comprising:
a first laser for emitting a first laser beam;
target means for receiving and sensing said first laser beam; and
a first range finder disposed at a known distance from said first laser and at a known angle with respect to said first laser beam; said first range finder determining the distance from itself to said target means.

261. A tracking system as recited in claim 260 wherein said target means comprises a sensor for sensing the presence or absence of said first laser beam; means for positioning said sensor so that said sensor receives the peak energy transmitted by said first laser beam.

262. A tracking system as recited in claim 261 wherein said target comprises optical box means for focusing said first laser beam upon said sensor and wherein said sensor is fixedly mounted within said optical box means and said optical box means further comprises a lens for receiving and focusing said first laser beam upon said sensor.

263. A tracking system as recited in claim 262 wherein said first range finder comprises means for emitting three laser beams; said first range finder using said three laser beams for determining the distance from said first range finder to said optical box.

264. A tracking system as recited in claim 263 further comprising a second range finder disposed at a known distance from said first laser and at a known angle to said first laser beam; said second range finder comprising means for emitting three laser beams; said second range finder using said three laser beams for determining the distance from said second range finder to said optical box.
